(19) United States
(12) Patent Application Publication
(10) Pub. No.: US 2026/0338026 A1
(43) Pub. Date: Oct. 29, 2026

(54) ARTIFICIALLY INTELLIGENT VEHICLE STORAGE ASSISTANCE

(71) Applicant: Volvo Car Corporation, Göteborg (SE)

(72) Inventors: Faijas Thai Thottathil, Gothenburg (SE); Amir Pilehvar, Rosenheim (DE); Arvid Englund, Gothenburg (SE); Saeed Mohammad Salehi, Västra Frölunda (SE)

(21) Appl. No.: 19/188,575

(22) Filed: Apr. 24, 2025

(51) Int. Cl. E05F 15/76; B60R 25/01; B60R 25/10; B60R 25/25; B60R 25/31; E05B 81/56; E05F 15/73

(52) U.S. Cl. CPC E05F 15/76; B60R 25/01; B60R 25/10; B60R 25/25; B60R 25/257; B60R 25/31; E05B 81/56; E05F 2015/767; E05Y 2400/8505; E05Y 2900/53

(57) ABSTRACT

Systems/techniques that facilitate artificially intelligent vehicle storage assistance are provided. In various embodiments, a system onboard a vehicle can detect one or more passengers approaching the vehicle. In various aspects, the system can detect, via an artificial intelligence model, objects that the one or more passengers are holding and external objects around the vehicle. In various instances, the system can open one or more access points of the vehicle based on the objects that the one or more passengers are holding and the external objects around the vehicle.

### TECHNICAL FIELD

The subject disclosure relates generally to artificial intelligence, and more specifically to artificially intelligent vehicle storage assistance.

### BACKGROUND

Vehicle occupants frequently approach their vehicles with their hands occupied, such as when carrying groceries, holding toddlers, or managing other personal items. In such scenarios, opening access points of their vehicles, such as doors or trunks, can be difficult or infeasible. In some cases, vehicles can be equipped with hands-free mechanisms, such as foot-activated trunk opening features. Unfortunately, existing techniques for addressing or assisting vehicle occupants who have occupied hands can be unreliable.

Accordingly, systems or techniques that can address one or more of these technical problems can be desirable.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate artificially intelligent vehicle storage assistance are described.

According to one or more embodiments, a system is provided. The system can be onboard a vehicle, and the system can comprise a memory that stores computer executable components. The system can further comprise a processor that executes the computer executable components stored in the memory. In various embodiments, the computer-executable components can comprise a recognition component that can detect one or more passengers approaching the vehicle. In various aspects, the computer-executable components can comprise a detection component can detect, via an artificial intelligence (AI) model, objects that the one or more passengers are holding and external objects around the vehicle. In various instances, the computer-executable components can comprise an execution component that can open one or more access points of the vehicle based on the objects that the one or more passengers are holding and the external objects around the vehicle.

According to one or more embodiments, the above-described system can be implemented as a computer-implemented method or a computer program product.

### DESCRIPTION OF THE DRAWINGS

FIG. 1 illustrates an example, non-limiting block diagram showing a vehicle that can facilitate artificially intelligent vehicle storage assistance in accordance with one or more embodiments described herein.

FIG. 2 illustrates another example, non-limiting block diagram showing a vehicle that can facilitate artificially intelligent vehicle storage assistance in accordance with one or more embodiments described herein.

FIG. 3 illustrates a block diagram of an example, non-limiting system that can facilitate artificially intelligent vehicle storage assistance in accordance with one or more embodiments described herein

FIG. 4 illustrates a block diagram of an example, non-limiting system including various sensors that can facilitate artificially intelligent vehicle storage assistance in accordance with one or more embodiments described herein.

FIG. 5 illustrates a block diagram of an example, non-limiting system including an artificial intelligence model that can facilitate artificially intelligent vehicle storage assistance in accordance with one or more embodiments described herein.

FIG. 6 illustrates an example, non-limiting block diagram showing how an artificial intelligence model can detect objects that one or more passengers approaching a vehicle are holding and objects around the vehicle in accordance with one or more embodiments described herein.

FIG. 7 illustrates a block diagram of an example, non-limiting system that can facilitate artificially intelligent vehicle storage assistance in accordance with one or more embodiments described herein.

FIG. 8 illustrates an example, non-limiting block diagram showing how an artificial intelligence model can determine access points to open in accordance with one or more embodiments described herein.

FIG. 9 illustrates a block diagram of an example, non-limiting system including a safety classification label that can facilitate artificially intelligent vehicle storage assistance in accordance with one or more embodiments described herein.

FIG. 10 illustrates an example, non-limiting block diagram showing how an artificial intelligence model can generate a safety classification label based on vicinity data in accordance with one or more embodiments described herein.

FIG. 11 illustrates an example, non-limiting block diagram of a safety classification label in accordance with one or more embodiments described herein.

FIG. 12 illustrates a block diagram of an example, non-limiting system including vehicle position adjustments, a notification component and an electronic alert that can facilitate artificially intelligent vehicle storage assistance in accordance with one or more embodiments described herein.

FIG. 13 illustrates an example, non-limiting block diagram of an electronic alert in accordance with one or more embodiments described herein.

FIG. 14 illustrates an example, non-limiting block diagram showing communication between an external device and a vehicle that can facilitate artificially intelligent vehicle storage assistance in accordance with one or more embodiments described herein.

FIG. 15 illustrates another example, non-limiting block diagram showing communication between an external device and a vehicle that can facilitate artificially intelligent vehicle storage assistance in accordance with one or more embodiments described herein.

FIG. 16 illustrates a block diagram of an example, non-limiting system including a training component and a training dataset that can facilitate artificially intelligent vehicle storage assistance in accordance with one or more embodiments described herein.

FIG. 17 illustrates an example, non-limiting block diagram of a training dataset in accordance with one or more embodiments described herein.

FIG. 18 illustrates an example, non-limiting block diagram showing how an artificial intelligence model can be trained in accordance with one or more embodiments described herein.

FIG. 19 illustrates an example, non-limiting block diagram showing a neighboring vehicle within a vicinity of a vehicle that can facilitate artificially intelligent vehicle storage assistance in accordance with one or more embodiments described herein.

FIGS. 20-22 illustrate flow diagrams of example, non-limiting computer-implemented methods that facilitate artificially intelligent vehicle storage assistance in accordance with one or more embodiments described herein.

FIG. 23 illustrates a block diagram of an example, non-limiting operating environment in which one or more embodiments described herein can be facilitated.

FIG. 24 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Vehicle occupants frequently approach their vehicles with their hands occupied, such as when carrying groceries, holding toddlers, or managing other personal items. In such scenarios, opening access points of their vehicles, such as doors or trunks, can be difficult or infeasible. In some cases, vehicles can be equipped with hands-free mechanisms, such as foot-activated trunk opening features. Unfortunately, existing techniques for addressing or assisting vehicle occupants who have occupied hands can be unreliable.

A vehicle occupant can approach a vehicle while carrying one or more items or entities (e.g., grocery bags, small children, personal belongings), which can result in the occupant having limited or no ability to manually operate vehicle access points (e.g., doors, trunks, liftgates, hatches, windows). For example, when a vehicle occupant is carrying grocery bags to put in the vehicle, the vehicle occupant may be unable to manually open the trunk or doors. As another example, a vehicle occupant that is carrying a child intended to be placed in a car seat in a rear seating area of the vehicle may be unable to open the door to access the car seat. As yet another example, a vehicle driver can be carrying large items that prevent the driver from unlocking and opening a vehicle through a key fob.

Unfortunately, existing techniques for assisting vehicle occupants carrying one or more items can be unreliable for various reasons.

First, existing techniques for enabling hands-free access to vehicle entry points (e.g., doors, trunks, liftgates) often rely on rigid, predefined activation gestures or commands. For example, some vehicles allow access by detecting a specific motion (e.g., a kicking motion beneath a designated area of the rear bumper), or through the manual activation of a remote key fob. Unfortunately, these existing techniques typically require the vehicle occupant to conform to a narrow range of expected actions or physical positions, regardless of the vehicle occupant's actual context. For instance, if the vehicle occupant is unable to perform a required foot gesture due to obstructed movement (e.g., standing on uneven ground, carrying a child), the vehicle will not activate to open the trunk. Moreover, these existing techniques do not accommodate variations in the vehicle occupant's behavior or physical capability, and thus can frequently result in access failures during real-world use cases. For example, if the vehicle occupant has limited physical mobility (e.g., uses a wheelchair) and cannot perform the foot gesture, existing techniques do not provide adaptive alternatives for activating the hands-free features.

Second, although some existing techniques incorporate sensors to detect the presence of a key fob or the proximity of the user, such existing techniques generally operate without evaluating environmental or situational safety conditions prior to initiating access. For example, a trunk may open automatically in response to a detected gesture or signal without assessing whether the surrounding area is safe or clear (e.g., whether a wall, pole, or pedestrian is in close proximity to the trunk). Such lack of environmental awareness can lead to unintended or unsafe activation of vehicle access points, resulting in property damage or personal injury. For example, a vehicle occupant may activate a hands-free feature to open a trunk of the vehicle in a parking garage where there is limited vertical clearance between the vehicle and ceiling, resulting in the trunk hitting the ceiling and damaging the vehicle. Furthermore, such existing techniques are typically unable to modify operation of the vehicle in response to real-time contextual hazards.

Third, existing techniques typically operate based on static conditions that do not account for changes in the vehicle occupant's physical capabilities or contextual needs. These existing techniques are often limited to a single mode of activation (e.g., a foot gesture or key fob activation), which may not be suitable in all circumstances. For example, a trunk may be more appropriate to open when a vehicle occupant is carrying large items (e.g., large boxes), whereas a rear door may be more appropriate when the vehicle occupant is carrying smaller personal items (e.g., a few grocery bags). As another example, a front passenger door may be more appropriate to open when the vehicle occupant is carrying fragile items (e.g., glass, ceramics). Such existing techniques do not adapt to what the vehicle occupant is carrying or provide alternative activation methods, leading to potential system failures or inconveniences for the vehicle occupant.

Accordingly, systems or techniques that can address one or more of these technical problems can be desirable.

Various embodiments described herein can address one or more of these technical problems. One or more embodiments described herein can include systems, computer-implemented methods, apparatus, or computer program products that can facilitate artificially intelligent vehicle storage assistance. That is, various disadvantages associated with existing techniques for assisting vehicle occupants carrying items can be ameliorated by artificially intelligent vehicle storage assistance.

More specifically, a vehicle can be outfitted with various external sensors to detect one or more passengers approaching the vehicle. Furthermore, the vehicle can detect objects that the one or more passengers are holding or external objects around the vehicle via the various external sensors. In various embodiments, the vehicle can be outfitted with an artificial intelligence model that can be trained or otherwise configured to determine which access points of the vehicle to open based on the objects that the one or more passengers are holding or the external objects around the vehicle. Thus, in various instances, the vehicle can execute the artificial intelligence model on vicinity data captured by the various sensors, which can cause the artificial intelligence model to detect and identify the objects that the one or more passengers are holding or the external objects around the vehicle. In various aspects, the artificial intelligence model can be trained or configured to identify a type or size of the objects that the one or more passengers are holding. Accordingly, based on the type or size of the objects, the artificial intelligence model can determine which access points are appropriate to open.

Additionally, the artificial intelligence model can be configured to identify a type or location of the external objects around the vehicle. Thus, the vehicle can execute the artificial intelligence model on vicinity data captured by the various sensors, which can cause the artificial intelligence model to generate a safety classification label. That is, based on the type or location of the external objects around the vehicle, the artificial intelligence model can generate the safety classification label.

Moreover, the vehicle can, in some cases, be outfitted with any suitable autonomous driving capabilities (e.g., autonomously adjustable steering input, autonomously adjustable throttle input, autonomously adjustable camera angles). Accordingly, the artificial intelligence model can be trained or otherwise configured to determine adjustments to operations of the vehicle based on the external objects around the vehicle and the safety classification label. Thus, the vehicle can execute the artificial intelligence model on the safety classification label, which can cause the artificial intelligence model to determine suitable adjustments to operations of the vehicle that can allow safe opening of the access points of the vehicle. For example, in various instances, the artificial intelligence model can determine an adjustment in the position of the vehicle that can enable safe opening of the access points of the vehicle (e.g., to avoid collision with external objects around the vehicle). As another example, in various cases, the artificial intelligence model can determine a maximum angle to open the access points that can enable safe opening of the access points of the vehicle (e.g., a maximum angle to open a door to prevent collision with a pole). In any case, the vehicle can perform the adjustments via the autonomous driving capabilities to enable safe and hands-free storage assistance to the one or more passengers.

Thus, such embodiments can be considered as effectively improving storage assistance to vehicle passengers.

Various embodiments described herein can be considered as a computerized tool (e.g., any suitable combination of computer-executable hardware or computer-executable software) that can facilitate artificially intelligent vehicle storage assistance. In various aspects, there can be a vehicle. In various instances, the vehicle can be outfitted with a computerized tool. In various cases, the computerized tool can comprise a sensor component, a recognition component, a detection component, an execution component, or an artificial intelligence (AI) component.

In various embodiments, the sensor component of the computerized tool can electronically record, measure, or otherwise capture vicinity data associated with a vicinity of the vehicle. More specifically, the sensor component can electronically access or otherwise control various sensors of the vehicle. Such sensors can include one or more cameras of the vehicle, one or more microphones of the vehicle, or one or more proximity sensors (e.g., radar, sonar, lidar) of the vehicle. In various aspects, the sensor component can leverage such sensors to obtain the vicinity data. For example, the one or more cameras can capture one or more images of the vicinity of the vehicle (e.g., images of roadways, sidewalks, traffic lights, buildings, pedestrians, trees, or other vehicles that are within any suitable distance in front of the vehicle, behind the vehicle, or beside the vehicle). As another example, the one or more microphones can record one or more noises that occur in the vicinity of the vehicle (e.g., noises that occur within any suitable distance in front of the vehicle, behind the vehicle, or beside the vehicle). As even another example, the one or more proximity sensors can measure one or more proximity detections associated with the vicinity (e.g., can detect tangible objects that are within any suitable distance in front of the vehicle, behind the vehicle, or beside the vehicle). In various cases, such one or more images, such one or more noises, or such one or more proximity detections can collectively be considered as the vicinity data.

In various embodiments, the recognition component of the computerized tool can detect one or more passengers approaching the vehicle. In various aspects, there can be a communication link between the vehicle and an external device (e.g., a key fob, a mobile device). In various cases, the communication link can be any suitable wireless electronic connection. In various embodiments, the external device can be carried or otherwise with the one or more passengers. Thus, the recognition component can detect the one or more passengers via the communication link with the external device. For instance, the recognition component can determine a location of the one or more passengers from the external device. In various embodiments, the recognition component can, in response to detecting the external device within a vicinity, direct the various sensors of the vehicle towards the external device to detect the one or more passengers.

In various embodiments, the artificial intelligence component of the computerized tool can electronically store, maintain, control, or otherwise access an AI model. In various instances, the AI model can exhibit any suitable internal architecture. For example, the AI model can include any suitable numbers of any suitable types of layers (e.g., input layer, one or more hidden layers, output layer, any of which can be convolutional layers, dense layers, non-linearity layers, pooling layers, batch normalization layers, or padding layers). As another example, the AI model can include any suitable numbers of neurons in various layers (e.g., different layers can have the same or different numbers of neurons as each other). As yet another example, the AI model can include any suitable activation functions (e.g., softmax, sigmoid, hyperbolic tangent, rectified linear unit) in various neurons (e.g., different neurons can have the same or different activation functions as each other). As still another example, the AI model can include any suitable interneuron connections or interlayer connections (e.g., forward connections, skip connections, recurrent connections).

In any case, the AI model can be configured to receive, as input, data captured, measured, or recorded by the various sensors of the sensor component and to detect, as output, objects that the one or more passengers are holding and external objects around the vehicle. Accordingly, in various aspects, the detection component can electronically execute the AI model on the vicinity data. In various instances, such execution can cause the AI model to identify the objects that the one or more passengers are holding and the external objects around the vehicle.

Furthermore, the AI model can be configured to determine which access points of the vehicle to open based on the objects that the one or more passengers are holding. That is, in response to identifying the objects that the one or more passengers are holding and the external objects around the vehicle (e.g., identifying a size, type, or location of the objects), the detection component can execute the AI model on the vicinity data to determine suitable access points to open (e.g., open the trunk in response to identifying large boxes held by a passenger, open a back seat door in response to identifying a child held by a passenger).

In any case, the AI model can be configured to determine if it is safe to open the access points based on the external objects around the vehicle. That is, in response to determining suitable access points to open, the detection component can execute the AI model on the vicinity data to generate a safety classification label. In various cases, the outputted safety classification label can be one or more scalars, one or more vectors, one or more matrices, one or more tensors, or one or more character strings that indicate whether or not it is safe to open the access points of the vehicle. In some instances, if the outputted safety classification label indicates that an external object around the vehicle prevents safe opening of an access point, then the outputted classification label can further indicate any suitable vehicle operation adjustments to enable safe opening of the access point. As a non-limiting example, the outputted safety classification label can include any suitable scalars, vectors, matrices, tensors, or character strings indicating an adjustment in a position of the vehicle. As another non-limiting example, the outputted classification label can include any suitable scalars, vectors, matrices, tensors, or character strings indicating a risk level of opening one or more access points of the vehicle. As yet another non-limiting example, the outputted classification label can include any suitable scalars, vectors, matrices, tensors, or character strings indicating if there is a hostile environment.

In various embodiments, the execution component of the computerized tool can electronically control, adjust, or otherwise manipulate any suitable electronically-controllable features of the vehicle. In various aspects, such electronically-controllable features can include electronically-controllable access points (e.g., one or more doors of the vehicle whose angle of opening can be electronically adjusted, a trunk whose angle of opening can be electronically adjusted). In various instances, such electronically-controllable features can include electronically-controllable cameras of the vehicle (e.g., one or more cameras of the vehicle whose angles or zoom levels can be electronically adjusted). In various instances, such electronically-controllable features can include electronically-controllable steering of the vehicle (e.g., one or more wheels of the vehicle whose steering angles can be electronically adjusted). In various cases, such electronically-controllable features can include electronically-controllable throttles of the vehicle (e.g., one or more wheels of the vehicle whose rotational speeds or torques can be electronically adjusted). In various aspects, such electronically-controllable features can include electronically-controllable braking of the vehicle (e.g., one or more brake pads of the vehicle whose application levels or compression levels can be electronically adjusted).

In various embodiments, the execution component of the first computerized tool can, in response to the outputted safety classification label indicating that it is or is not safe to open the access points of the vehicle, electronically control, adjust, or otherwise manipulate any suitable electronically-controllable features of the vehicle. For example, if the outputted safety classification label indicates that it is safe to open the access points, the execution component can open the access points. Conversely, if the outputted safety classification label indicates that it is not safe to open the access points, the execution component can electronically control steering, throttle, or braking of the vehicle to adjust a position of the vehicle. As another example, if the outputted safety classification label indicates that there is a hostile environment, the execution component can lock all access points of the vehicle (e.g., to prevent an intruder from getting in the car).

Various embodiments described herein can be employed to use hardware or software to solve problems that are highly technical in nature (e.g., to facilitate artificially intelligent vehicle storage assistance), that are not abstract and that cannot be performed as a set of mental acts by a human. Further, some of the processes performed can be performed by a specialized computer (e.g., an AI model having internal parameters such as convolutional kernels) for carrying out defined tasks related to artificially intelligent vehicle storage assistance.

For example, such defined tasks can include: detecting, by a device operatively coupled to a processor, onboard a vehicle, and via one or more sensors of the vehicle, one or more passengers approaching the vehicle; detecting, by the device and via execution of an AI model on vicinity data captured by the one or more sensors, detecting objects that the one or more passengers are holding and external objects around the vehicle; and electronically opening, by the device, one or more access points of the vehicle based on the objects that the one or more passengers are holding and the external objects around the vehicle.

Such defined tasks are not performed manually by humans. Indeed, neither the human mind nor a human with pen and paper can: electronically capture, measure, or otherwise record vicinity data using vehicle sensors (e.g., cameras, microphones, or proximity sensors); electronically detect one or more passengers via the vehicle sensors; detect objects that the one or more passengers are holding or external objects around the vehicle by executing an AI model on such vicinity data; and electronically controlling operation of the vehicle to open one or more access points based on the objects that the one or more passengers are holding and the external objects around the vehicle. Indeed, vehicle sensors and AI models are inherently-computerized devices that simply cannot be implemented in any way by the human mind without computers. Accordingly, a computerized tool that can control vehicle sensors and that can train or execute an AI model on data captured by such vehicle sensors is likewise inherently-computerized and cannot be implemented in any sensible, practical, or reasonable way without computers.

Furthermore, various embodiments described herein can control real-world tangible devices based on the disclosed teachings. For example, various embodiments described herein can electronically control real-world vehicle sensors (e.g., real-world vehicle cameras, real-world vehicle microphones, real-world vehicle proximity detectors), can electronically execute (or train) real-world AI models on data captured by such real-world vehicle sensors, and can electronically transmit alerts outputted by such real-world AI models.

It should be appreciated that the herein figures and description provide non-limiting examples of various embodiments and are not necessarily drawn to scale.

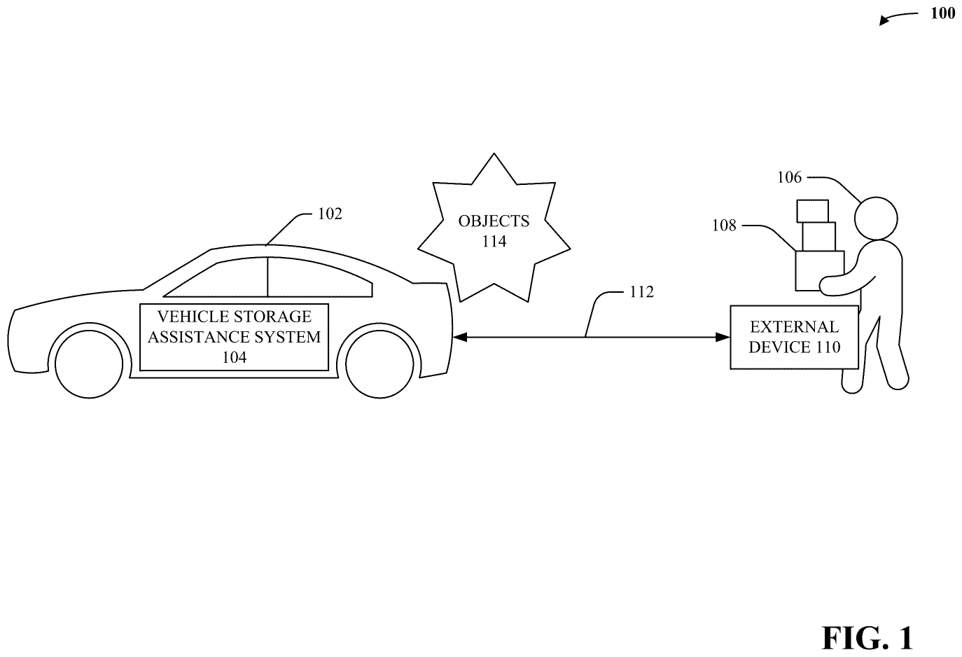

FIG. 1 illustrates an example, non-limiting block diagram 100 showing a vehicle that can facilitate artificially intelligent vehicle storage assistance in accordance with one or more embodiments described herein.

In various embodiments, there can be a vehicle 102. In various aspects, the vehicle 102 can be any suitable vehicle or automobile (e.g., can be a car, a truck, a van, a motorcycle). In various instances, the vehicle 102 can have or otherwise exhibit any suitable type of propulsion system (e.g., can be an electric vehicle, can be a gasoline-powered or diesel-powered vehicle, can be a hybrid vehicle). In some cases, the vehicle 102 can be parked (e.g., can be parked in a parking lot, by a curb, or in a driveway).

In any case, the vehicle 102 can comprise, have, or otherwise be outfitted or equipped with a vehicle storage assistance system 104. In other words, the vehicle storage assistance system 104 can be onboard the vehicle 102.

In various aspects, there can be a passenger 106 (e.g., or more than one passenger) of the vehicle. In various instances, the passenger 106 can be approaching the vehicle 102. Furthermore, in various cases, the passenger 106 can be holding objects 108 (e.g., personal items, a child, grocery bags, boxes). In various instances, the passenger 106 can be any suitable distance away from the vehicle 102 (e.g., can be within mere feet of the vehicle 102).

In various cases, the passenger 106 can have an external device 110. In various aspects, the external device 110 can be any suitable device that can facilitate communication or interaction between vehicle 102 and passenger 106. As a non-limiting example, the external device 110 can be a key fob. As another non-limiting example, the external device 110 can be a mobile phone (e.g., a smart phone).

In various embodiments, the vehicle storage assistance system 104 can electronically share any suitable data with the external device 110, via a communication link 112. In other words, the vehicle storage assistance system 104 and the external device 110 can be communicatively coupled together by the communication link 112. In various aspects, as described herein, the vehicle storage assistance system 104 can detect the passenger 106 from detecting the external device 110. In various instances, the communication link 112 can be any suitable wireless electronic communication channel. In some cases, the communication link 112 can be any suitable Internet connection that utilizes one or more intermediate access points or intermediate routers. In other cases, the communication link 112 can be any suitable P2P connection that can operate or otherwise function in the absence of an intermediate access point or intermediate router. Non-limiting examples of such a P2P connection can include a BLUETOOTH® P2P connection or a Wi-Fi P2P connection (e.g., such as Wi-Fi DIRECT®). In other instances, as described herein, the vehicle storage assistance system 104 can continually or periodically scan, using vehicle sensors and deep learning, the vicinity for the passenger 106.

In various aspects, there can be objects 114 (e.g., external objects 114) around the vehicle 102. In various embodiments, as described herein, the vehicle storage assistance system 104 can continually or periodically scan, using vehicle sensors and deep learning, the vicinity for objects 114.

When passenger 106 approaches the vehicle 102, the vehicle storage assistance system 104 can, as described herein, automatically detect the passenger 106 (e.g., by detecting external device 110), objects 108 that passenger 106 is holding, and objects 114 around the vehicle. Upon such detection, the vehicle storage assistance system 104 can, as described herein, determine, via deep learning, which access points of vehicle 102 to open to facilitate adaptable hands-free control of vehicle 102 for passenger 106. Furthermore, the vehicle storage assistance system 104 can, as described herein, determine, via deep learning, if it is safe to open the one or more access points based on the objects 114.

As also described herein, the vehicle storage assistance system 104 can take any suitable electronic actions, based on a determination of access points to open and a determination that it is or is not safe to open the access points (e.g., open an access point, lock an access point, move the vehicle 102).

In some cases, because the vehicle 102 can comprise the vehicle storage assistance system 104, the vehicle 102 can be considered as a smart vehicle.

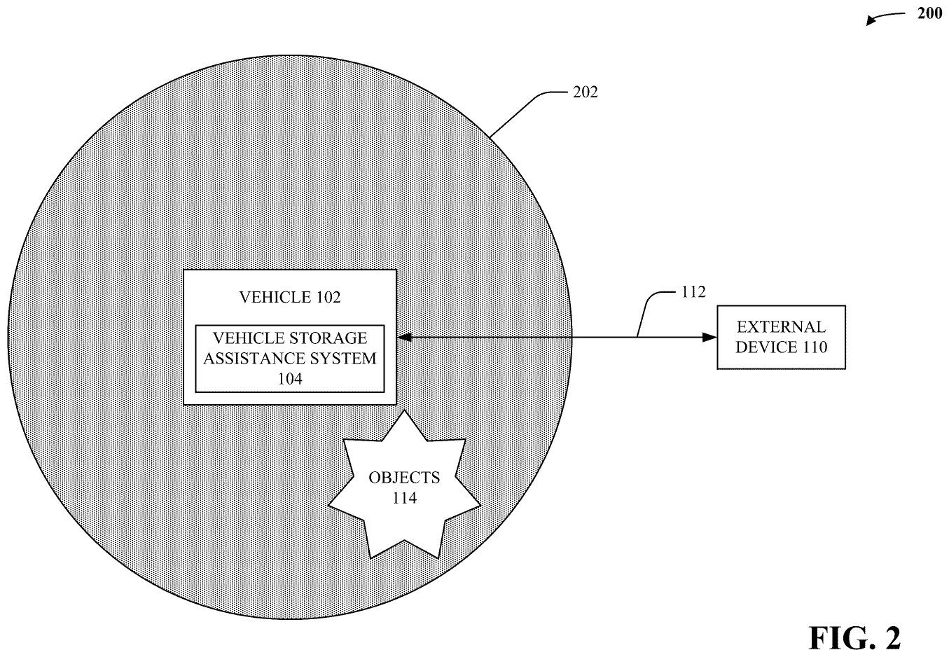

FIG. 2 illustrates another example, non-limiting block diagram 200 showing vehicle 102 that can facilitate artificially intelligent vehicle storage assistance in accordance with one or more embodiments described herein.

As described herein, the vehicle storage assistance system 104 can electronically monitor a vicinity 202 of the vehicle 102 for external objects 114, passenger 106, or objects 108. Whenever a passenger (e.g., 106) is detected, the vehicle storage assistance system 104 can automatically scan the vicinity 202 to detect external objects 114 around the vehicle 102 and objects 108 that passenger 106 is holding.

In various aspects, the vicinity 202 can be any suitable physical area that encompasses the immediate or nearby surroundings of the vehicle 102. In other words, the vicinity 202 can be any suitable physical area or physical space that is within any suitable threshold distance in front of, beside, or behind the vehicle 102. In some cases, as depicted in FIG. 1, the vicinity 202 can be considered as a circular space swept by any suitable radius extending from the vehicle 102 (e.g., the vehicle 102 can be at the center of such circular space, and such circular space can be considered as moving with the vehicle 102 as the vehicle 102 moves). Although FIG. 1 depicts the vicinity 202 as being circular, this is a mere non-limiting example for ease of illustration. In various aspects, the vicinity 202 can have any suitable shape (e.g., a regular shape or an irregular shape). In any case, the vicinity 202 can be considered as encompassing whatever surroundings happen to be near the vehicle 102 at any given instant in time. Accordingly, depending upon a current location of the vehicle 102, the vicinity 202 can encompass one or more other vehicles (not shown), one or more buildings or portions of buildings (not shown), one or more street lanes (not shown), one or more street curbs (not shown), one or more highway medians (not shown), one or more sidewalks (not shown), one or more ditches or other off-road portions (not shown), one or more pedestrians (not shown), one or more animals (not shown), or any other suitable objects or fixtures (e.g., power poles, street lamps, street signs, fire hydrants, mailboxes, bus stops, benches).

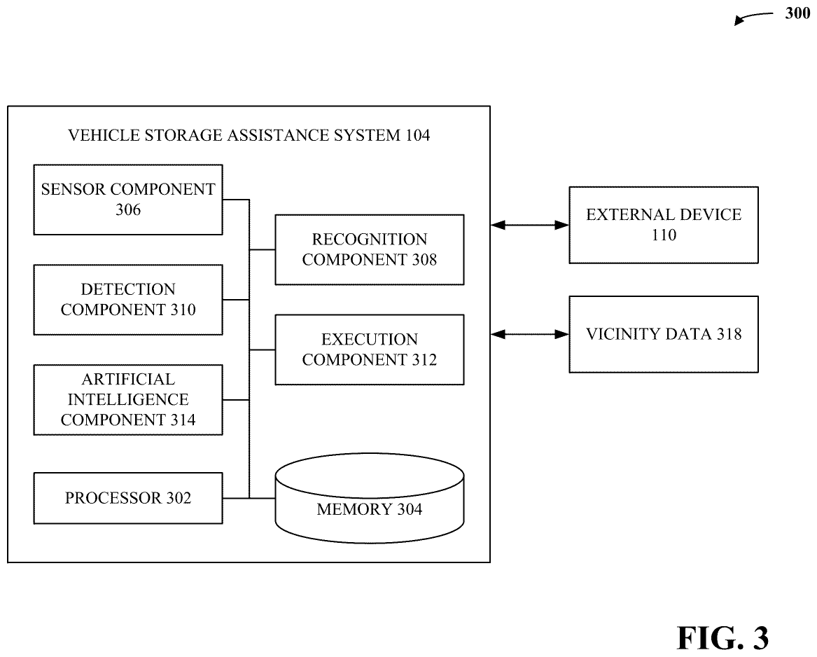

FIG. 3 illustrates a block diagram of an example, non-limiting system 200 that can facilitate artificially intelligent vehicle storage assistance in accordance with one or more embodiments described herein. In other words, FIG. 3 depicts a non-limiting example embodiment of the vehicle storage assistance system 104.

In various embodiments, the vehicle storage assistance system 104 can comprise a processor 302 (e.g., computer processing unit, microprocessor) and a non-transitory computer-readable memory 304 that is operably or operatively or communicatively connected or coupled to the processor 302. The non-transitory computer-readable memory 304 can store computer-executable instructions which, upon execution by the processor 302, can cause the processor 302 or other components of the vehicle storage assistance system 104 (e.g., sensor component 306, recognition component 308, detection component 310, execution component 312, artificial intelligence (AI) component 314) to perform one or more acts. In various embodiments, the non-transitory computer-readable memory 304 can store computer-executable components (e.g., sensor component 306, recognition component 308, detection component 310, execution component 312, AI component 314), and the processor 302 can execute the computer-executable components.

In various embodiments, the vehicle storage assistance system 104 can comprise a sensor component 306. In various aspects, as described herein, the sensor component 306 can obtain, via any suitable sensors of the vehicle 102, vicinity data 318. In various cases, the vicinity data 318 can exhibit any suitable format, size, or dimensionality. For example, the vicinity data 318 can comprise one or more scalars, one or more vectors, one or more matrices, one or more tensors, one or more character strings, or any suitable combination thereof.

In various embodiments, the vehicle storage assistance system 104 can comprise a recognition component 308. In various instances, as described herein, the recognition component 308 can detect passenger 106 (e.g., one or more passengers 106) approaching the vehicle 102. In various cases, the recognition component 308 can detect external device 110 to detect passenger 106. In other cases, the recognition component 308 can engage the artificial intelligence component 314 to detect passenger 106 within the vicinity 202 based on the vicinity data 318.

In various instances, the recognition component 308 can communicate with the external device 110 to verify an identity of passenger 106. For instance, the recognition component 308 can, as described herein, verify the identity of passenger 106 via audio recognition or facial recognition.

In various embodiments, the vehicle storage assistance system 104 can comprise a detection component 310. In various cases, as described herein, the detection component 310 can engage the artificial intelligence component 314 to detect objects 108 that passenger 106 is holding and objects 114 in the vicinity 202 based on the vicinity data 318. In various aspects, as described herein, the detection component 310 can engage the artificial intelligence component 314 to identify objects 108 and objects 114. For instance, the detection component 310 can identify a type or size of objects 108. Similarly, the detection component 310 can identify a type or location of objects 114 relative to vehicle 102.

In various embodiments, the vehicle storage assistance system 104 can comprise an execution component 312. In various aspects, execution component 312 can engage the artificial intelligence component 314 to determine which access points of vehicle 102 to open based on the objects 108 and objects 114 to mitigate potential property damage or personal injury while enabling adaptable storage assistance to passenger 106. Thus, the vehicle storage assistance system 104 can enable automatic storage assistance that can open a closest and safest access point of vehicle 102 for passenger 106.

In various aspects, the vehicle 102 can be outfitted or otherwise equipped with any suitable autonomous or electronically-controllable features, such as autonomous or electronically-controllable access points, autonomous or electronically-controllable cameras, autonomous or electronically-controllable speakers, autonomous or electronically-controllable steering, autonomous or electronically-controllable throttle, or autonomous or electronically-controllable braking. In various instances, such autonomous or electronically-controllable features can be governed or otherwise orchestrated by the execution component 312. In various embodiments, as described herein, the execution component 312 can control such autonomous or electronically-controllable features based on the objects 108 and objects 114 detected to enable adaptable hands-free control of vehicle 102 for passenger 106. That is, execution component 312 can control such autonomous or electronically-controllable features to automatically open the access points for passenger 106.

As a non-limiting example, if detection component 310 detects that passenger 106 is carrying a child, execution component 312 can operate the autonomous or electronically-controllable access points to open a rear seat door as the passenger 106 approaches vehicle 102. As another non-limiting example, if detection component 310 detects that there is a pole blocking the rear door, execution component 312 can operate the autonomous or electronically-controllable cameras, steering, throttle, and braking to adjust a position of the vehicle 102 as the passenger 106 approaches. As yet another non-limiting example, if detection component 310 detects that there is limited vertical clearance to open the trunk, execution component 312 can operate the autonomous or electronically-controllable access points to open the trunk at a maximum angle that prevents the trunk from hitting a ceiling.

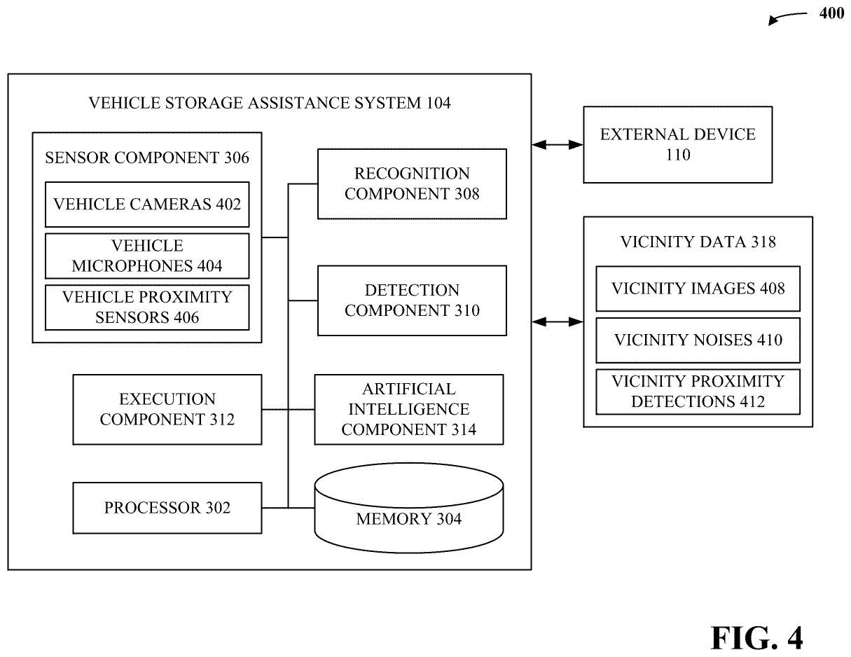

FIG. 4 illustrates a block diagram of an example, non-limiting system 400 including various sensors that can facilitate artificially intelligent vehicle storage assistance in accordance with one or more embodiments described herein.

In various embodiments, the sensor component 306 can electronically control, electronically execute, electronically activate, or otherwise electronically access any suitable sensors of the vehicle 102. In various aspects, such sensors can be external or road-facing. In other words, such sensors can be oriented or otherwise configured to monitor the vicinity 202 (e.g., the surroundings of the vehicle 102) as the vehicle 102 drives around or is parked.

As a non-limiting example, such sensors can include a set of vicinity images 408. In various aspects, the set of vicinity images 408 can include any suitable number of any suitable types of cameras (e.g., of image-capture devices). In various instances, the set of vicinity images 408 can be integrated into or onto the vehicle 102. In various cases, one or more of the set of vicinity images 408 can be forward-facing. For example, such one or more cameras can be integrated into or onto any suitable forward-facing surfaces, whether interior or exterior, of the vehicle 102 (e.g., can be built on a dash of the vehicle 102 so as to look through a front windshield of the vehicle 102, can be built around the front windshield of the vehicle 102, can be built into a front bumper of the vehicle 102, can be built around headlights of the vehicle 102, can be built into a hood of the vehicle 102). Because such one or more cameras can be forward-facing, such one or more cameras can be configured to capture or otherwise record images or video frames of portions of the vicinity 202 that lie in front of the vehicle 102. In various aspects, one or more of the set of vicinity images 408 can be rearward-facing. For example, such one or more cameras can be integrated into or onto any suitable rearward-facing surfaces, whether interior or exterior, of the vehicle 102 (e.g., can be built into or on a rearview mirror of the vehicle 102, can be built into or onto sideview mirrors of the vehicle 102, can be built around a rear windshield of the vehicle 102, can be built into a rear bumper of the vehicle 102, can be built around taillights of the vehicle 102, can be built into a trunk-cover of the vehicle 102). Because such one or more cameras can be rearward-facing, such one or more cameras can be configured to capture or otherwise record images or video frames of portions of the vicinity 202 that lie behind the vehicle 102. In various instances, one or more of the set of vicinity images 408 can be laterally-facing. For example, such one or more cameras can be integrated into or onto any suitable lateral surfaces, whether interior or exterior, of the vehicle 102 (e.g., can be built into or around doors or door handles of the vehicle 102, can be built into or around fenders of the vehicle 102). Because such one or more cameras can be laterally-facing, such one or more cameras can be configured to capture or otherwise record images or video frames of portions of the vicinity 202 that lie beside the vehicle 102.

As another non-limiting example, such sensors can include a set of vehicle microphones 404. In various aspects, the set of vehicle microphones 404 can include any suitable number of any suitable types of microphones (e.g., of sound-capture devices). In various instances, the set of vehicle microphones 404 can be integrated into or onto the vehicle 102. In various cases, one or more of the set of vehicle microphones 404 can be forward-facing. For example, such one or more microphones can be integrated into or onto any suitable forward-facing surfaces, whether interior or exterior, of the vehicle 102, so as to capture or otherwise record sounds or noises that occur in portions of the vicinity 202 that lie in front of the vehicle 102. In various aspects, one or more of the set of vehicle microphones 404 can be rearward-facing. For example, such one or more microphones can be integrated into or onto any suitable rearward-facing surfaces, whether interior or exterior, of the vehicle 102, so as to capture or otherwise record sounds or noises that occur in portions of the vicinity 202 that lie behind the vehicle 102. In various instances, one or more of the set of vehicle microphones 404 can be laterally-facing. For example, such one or more microphones can be integrated into or onto any suitable lateral surfaces, whether interior or exterior, of the vehicle 102, so as to capture or otherwise record sounds or noises that occur in portions of the vicinity 202 that lie beside the vehicle 102.

As still another non-limiting example, such sensors can include a set of vehicle proximity sensors 410. In various aspects, the set of vehicle proximity sensors 410 can include any suitable number of any suitable types of proximity sensors (e.g., of radar, sonar, or lidar sensors). In various instances, the set of vehicle proximity sensors 410 can be integrated into or onto the vehicle 102. In various cases, one or more of the set of vehicle proximity sensors 410 can be forward-facing. For example, such one or more proximity sensors can be integrated into or onto any suitable forward-facing surfaces, whether interior or exterior, of the vehicle 102, so as to capture or otherwise record proximities of tangible objects located in portions of the vicinity 202 that lie in front of the vehicle 102. In various aspects, one or more of the set of vehicle proximity sensors 410 can be rearward-facing. For example, such one or more proximity sensors can be integrated into or onto any suitable rearward-facing surfaces, whether interior or exterior, of the vehicle 102, so as to capture or otherwise record proximities of tangible objects located in portions of the vicinity 202 that lie behind the vehicle 102. In various instances, one or more of the set of vehicle proximity sensors 410 can be laterally-facing. For example, such one or more proximity sensors can be integrated into or onto any suitable lateral surfaces, whether interior or exterior, of the vehicle 102, so as to capture or otherwise record proximities of tangible objects located in portions of the vicinity 202 that lie beside the vehicle 102.

In any case, the sensor component 306 can utilize such sensors to capture, record, or otherwise measure the vicinity data 318.

For example, the set of vehicle cameras 402 can capture a set of vicinity images 408 while the vehicle 102 is \parked. In various aspects, the set of vicinity images 408 can include any suitable number of images or video frames (e.g., any suitable number of two-dimensional pixel arrays) that can depict portions of the vicinity 202 (e.g., portions of the vicinity 202 that lie in front of, behind, or beside the vehicle 102).

As another example, the set of vehicle microphones 404 can capture a set of vicinity noises 410 while the vehicle 102 is parked. In various instances, the set of vicinity noises 410 can include any suitable number of audio clips that can represent noises occurring in portions of the vicinity 202 (e.g., in portions of the vicinity 202 that lie in front of, behind, or beside the vehicle 102).

As even another example, the set of vehicle proximity sensors 410 can capture a set of vicinity proximity detections 412 while the vehicle 102 is parked. In various aspects, the set of vicinity proximity detections 412 can include any suitable number of proximity detections (e.g., of radar, sonar, or lidar detections) that can represent distances between the vehicle 102 and nearby objects located in portions of the vicinity 202 (e.g., in portions of the vicinity 202 that lie in front of, behind, or beside the vehicle 102).

Although not explicitly shown in the figures, any of the set of vehicle cameras 402, any of the set of vehicle microphones 404, or any of the set of vehicle proximity sensors 410 can be integrated into or onto a drone (e.g., an autonomous or remotely-operated drone) that can be launched by, controlled by, or otherwise associated with the vehicle 102. For example, the vehicle 102 can launch an air-based or ground-based drone, and such drone can travel along with the vehicle 102 (e.g., can travel in front of the vehicle 102, behind the vehicle 102, or beside the vehicle 102). As such drone travels along with the vehicle 102, such drone can utilize any suitable sensors (e.g., cameras, microphones, thermometers, hygrometers, proximity sensors) integrated into or onto the drone to monitor the vicinity 202. In various cases, such drone can electronically transmit (e.g., via a P2P communication link) any data captured by its sensors back to the vehicle 102, and such captured data can be considered as part of the vicinity data 318.

In any case, the set of vicinity images 408, the set of vicinity noises 410, and the set of vicinity proximity detections 412 can collectively be considered as the vicinity data 318.

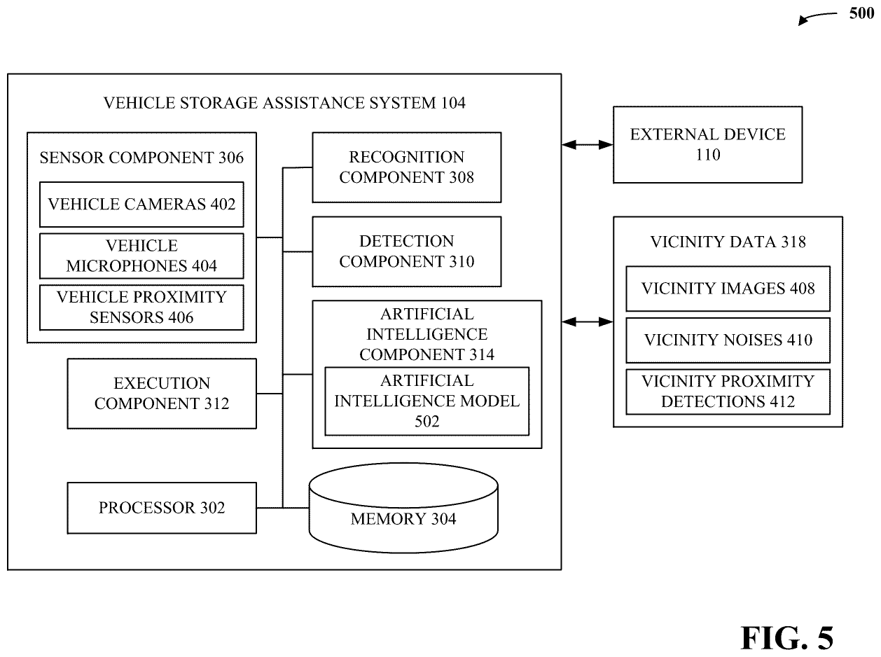

FIG. 5 illustrates a block diagram of an example, non-limiting system 500 including an AI model that can facilitate artificially intelligent vehicle storage assistance in accordance with one or more embodiments described herein. As shown, the system 500 can, in some cases, comprise the same components as the system 400, and can further comprise an AI model 502.

In various embodiments, the AI component 314 can electronically store, electronically maintain, electronically control, or otherwise electronically access the AI model 502. In various aspects, the AI model 502 can have or otherwise exhibit any suitable internal architecture. For instance, the AI model 502 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

No matter the internal architecture of the AI model 502, the AI model 502 can be configured to detect objects 108 that passenger 106 is holding and objects 114 around the vehicle based on inputted vicinity data. Accordingly, the detection component 310 can electronically execute the AI model 502 on the vicinity data 318, thereby yielding objects 602 and objects 608.

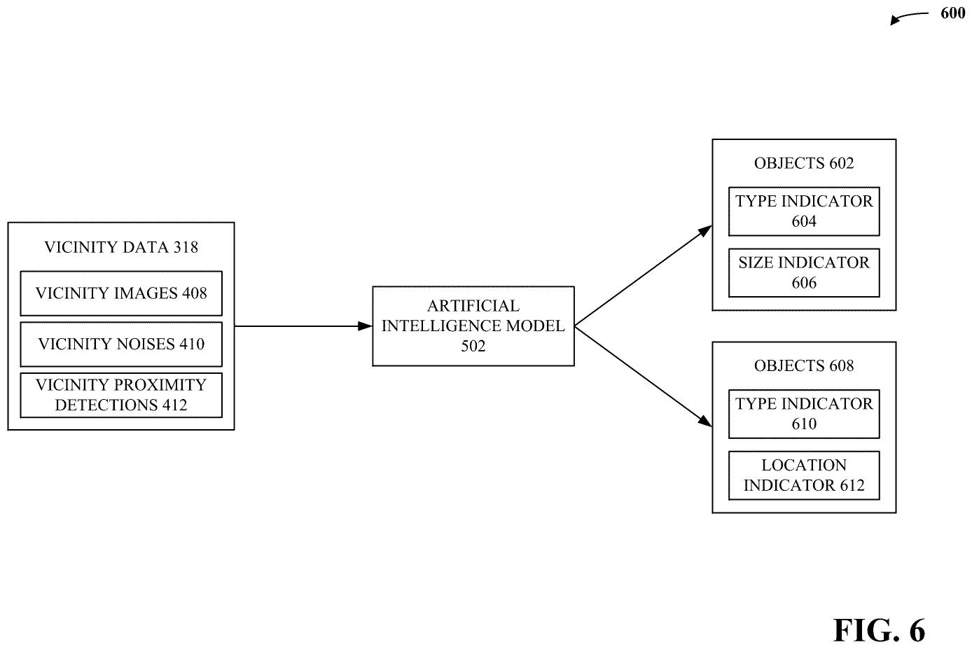

FIG. 6 illustrates an example, non-limiting block diagram 500 showing how the AI model 502 can detect objects 602 that one or more passengers approaching vehicle 102 are holding and objects 608 around vehicle 102 in accordance with one or more embodiments described herein.

As shown, the detection component 310 can, in various aspects, execute the AI model 502 on the vicinity data 318, and such execution can cause the AI model 502 to produce objects 602 and objects 608. More specifically, the detection component 310 can feed the vicinity data 318 (e.g., the set of vicinity images 408, the set of vicinity noises 410, or the set of vicinity proximity detections 412) to an input layer of the AI model 502. In various instances, the vicinity data 318 (e.g., the set of vicinity images 408, the set of vicinity noises 410, or the set of vicinity proximity detections 412) can complete a forward pass through one or more hidden layers of the AI model 502. In various cases, an output layer of the AI model 502 can compute the objects 602 and objects 608, based on activation maps or intermediate features produced by the one or more hidden layers.

In various aspects, objects 602 and objects 608 can be any suitable electronic data exhibiting any suitable format, size, or dimensionality. That is, the objects 602 and objects 608 can be one or more scalars, one or more vectors, one or more matrices, one or more tensors, one or more character strings, or any suitable combination thereof. In various instances, objects 602 can indicate, specify, convey, or otherwise represent any suitable characteristics, attributes, or properties of objects 108 that passenger 106 is holding. Similarly, objects 608 can indicate, specify, convey, or otherwise represent any suitable characteristics, attributes, or properties of objects 114 around vehicle 102.

In various aspects, as shown, objects 602 can comprise a type indicator 604. In various instances, the type indicator 604 can have any suitable format, size, or dimensionality. That is, the type indicator 604 can be one or more scalars, one or more vectors, one or more matrices, one or more tensors, one or more character strings, or any suitable combination thereof. In any case, the type indicator 604 can indicate, convey, or otherwise represent a type of objects 108 that passenger 106 is holding. For instance, the sensor component 306 can capture the vicinity data 318 when passenger 106 is detected, and the AI model 502 can be trained or otherwise configured, as described herein, to determine, based on the vicinity data 318, what types of objects 108 the passenger 106 is holding (e.g., children, personal items, boxes, groceries, bags). In other words, if passenger 106 is detected, some manifestation of objects 108 that the passenger 106 is holding can be conveyed in the vicinity data 318 (e.g., the objects can be depicted in the set of vicinity images 408, distinctive sounds of the objects can be captured in the set of vicinity noises 410, the objects can cause a distinctive anomaly in the set of vicinity proximity detections 412), and the AI model 502 can recognize such manifestation of the objects 108. For example, if the passenger 106 is holding a child, some manifestation of the child would be conveyed in the vicinity data 318 (e.g., the child would be depicted in the set of vicinity images 408, distinctive sounds of the child, such as crying sounds, would be captured in the set of vicinity noises 410, distinctive anomalies of the child would be in the set of vicinity proximity detections 412), and the AI model 502 can recognize such manifestation of the child. As another example, if the passenger 106 is holding grocery bags, some manifestation of the grocery bags would be conveyed in the vicinity data 318 (e.g., the grocery bags would be depicted in the set of vicinity images 408, distinctive sounds of the grocery bags, such as plastic bag sounds, would be captured in the set of vicinity noises 410, distinctive anomalies of the grocery bags would be in the set of vicinity proximity detections 412), and the AI model 502 can recognize such manifestation of the grocery bags. In any case, the type indicator 604 can represent the determination, inference, or conclusion generated by the AI model 502 with respect to what type of objects 108 the passenger 106 is holding.

As a non-limiting example, the type indicator 604 can be a multinomial variable that can take on one of three or more possible discrete states. In such case, the three or more possible discrete states can respectively represent any suitable object type labels. For instance, the type indicator 604 can have a “children” state, a “grocery bags” state, a “personal items” state, or a “boxes” state.

In various aspects, as shown, the objects 602 can comprise a size indicator 606. In various instances, the size indicator 606 can have any suitable format, size, or dimensionality. That is, the size indicator 606 can be one or more scalars, one or more vectors, one or more matrices, one or more tensors, one or more character strings, or any suitable combination thereof. In any case, the size indicator 606 can indicate, convey, or otherwise represent a size of objects 108 that passenger 106 is holding. For instance, the sensor component 306 can capture the vicinity data 318 when the passenger 106 is detected, and the AI model 502 can be trained or otherwise configured, as described herein, to determine, based on the vicinity data 318, a size of objects 108 that passenger 106 is holding. In other words, if passenger 106 is detected, some manifestation of the size of objects that the passenger 106 is holding can be conveyed in the vicinity data 318 (e.g., the size of the objects can be depicted in the set of vicinity images 408, the objects can cause a distinctive anomaly in the set of vicinity proximity detections 412), and the AI model 502 can recognize such manifestation of the size of objects 108. In any case, the size indicator 606 can represent the determination, inference, or conclusion generated by the AI model 502 with respect to the size of objects 108.

As a non-limiting example, the size indicator 606 can be a scalar whose magnitude represents a size (in any suitable unit) of objects 108. As another non-limiting example, the size indicator 606 can be a multinomial variable that can take on one of three or more possible discrete states. In such case, the three or more possible discrete states can respectively represent any suitable object size labels. For instance, the size indicator 606 can have a “small” state, a “medium” state, or a “large” state.

Although not explicitly shown in FIG. 6, the objects 602 can comprise any other suitable indicators. As a non-limiting example, the objects 602 can comprise a presence indicator (not shown), which can exhibit any suitable size, format, or dimensionality, and which can binomially, multinomially, discretely, or continuously indicate whether passenger 106 is holding objects or not holding objects.

In any case, the detection component 310 can execute the AI model 502 on the vicinity data 318, thereby yielding the objects 602.

In various aspects, as shown, objects 608 can comprise a type indicator 610. In various instances, the type indicator 610 can have any suitable format, size, or dimensionality. That is, the type indicator 610 can be one or more scalars, one or more vectors, one or more matrices, one or more tensors, one or more character strings, or any suitable combination thereof. In any case, the presence type indicator 610 can indicate, convey, or otherwise represent a type of objects 114 around vehicle 102. For instance, the sensor component 306 can capture the vicinity data 318 when passenger 106 is detected, and the AI model 502 can be trained or otherwise configured, as described herein, to determine, based on the vicinity data 318, what types of objects 114 are around vehicle 102 (e.g., poles, other vehicles, pedestrians, grocery carts, fencing). In other words, some manifestation of objects 114 around vehicle 102 can be conveyed in the vicinity data 318 (e.g., the objects can be depicted in the set of vicinity images 408, distinctive sounds of the objects can be captured in the set of vicinity noises 410, the objects can cause a distinctive anomaly in the set of vicinity proximity detections 412), and the AI model 502 can recognize such manifestation of the objects 114. For example, if there is another vehicle parked next to vehicle 102, some manifestation of the other vehicle would be conveyed in the vicinity data 318 (e.g., the vehicle would be depicted in the set of vicinity images 408, distinctive sounds of the vehicle would be captured in the set of vicinity noises 410, distinctive anomalies of the vehicle would be in the set of vicinity proximity detections 412), and the AI model 502 can recognize such manifestation of the vehicle. As another example, if vehicle 102 is parked next to a pole, some manifestation of the pole would be conveyed in the vicinity data 318 (e.g., the pole would be depicted in the set of vicinity images 408, distinctive anomalies of the pole would be in the set of vicinity proximity detections 412), and the AI model 502 can recognize such manifestation of the pole. In any case, the type indicator 610 can represent the determination, inference, or conclusion generated by the AI model 502 with respect to what type of objects 114 are around vehicle 102.

As a non-limiting example, the type indicator 610 can be a multinomial variable that can take on one of three or more possible discrete states. In such case, the three or more possible discrete states can respectively represent any suitable object type labels. For instance, the type indicator 610 can have a “pedestrian” state, a “vehicle” state, a “barriers” state, or a “moveable obstructions” state.

In various aspects, as shown, the objects 608 can comprise a location indicator 612. In various instances, the location indicator 612 can have any suitable format, size, or dimensionality. That is, the location indicator 612 can be one or more scalars, one or more vectors, one or more matrices, one or more tensors, one or more character strings, or any suitable combination thereof. In any case, the location indicator 612 can indicate, convey, or otherwise represent a size of objects 114 that passenger 106 is holding. For instance, the sensor component 306 can capture the vicinity data 318 when the passenger 106 is detected, and the AI model 502 can be trained or otherwise configured, as described herein, to determine, based on the vicinity data 318, a size of objects 114 that passenger 106 is holding. In other words, if passenger 106 is detected, some manifestation of the size of objects that the passenger 106 is holding can be conveyed in the vicinity data 318 (e.g., the size of the objects can be depicted in the set of vicinity images 408, the objects can cause a distinctive anomaly in the set of vicinity proximity detections 412), and the AI model 502 can recognize such manifestation of the size of objects 114. In any case, the location indicator 612 can represent the determination, inference, or conclusion generated by the AI model 502 with respect to the size of objects 114.

As a non-limiting example, the location indicator 612 can be a scalar whose magnitude represents location coordinates of objects 114 relative to vehicle 102. As another non-limiting example, the location indicator 612 can be a multinomial variable that can take on one of three or more possible discrete states. In such case, the three or more possible discrete states can respectively represent an area around vehicle 102 where the objects 114 are. For instance, the location indicator 612 can have a “rear” state, a “side” state, or a “front” state. In other instances, the location indicator 612 can have a “trunk” state, “a left rear door” state, a “right rear door” state, a “left front door” state, a “right front door” state, or a “front hatch” state.

Although not explicitly shown in FIG. 6, the objects 608 can comprise any other suitable indicators. As a non-limiting example, the objects 608 can comprise a presence indicator (not shown), which can exhibit any suitable size, format, or dimensionality, and which can binomially, multinomially, discretely, or continuously indicate whether there are objects around vehicle 102. As another non-limiting example, the objects 608 can comprise a size indicator (not shown), which can exhibit any suitable size, format, or dimensionality, and which can binomially, multinomially, discretely, or continuously indicate a size of objects 118. As still another non-limiting example, the objects 608 can comprise a hazardous indicator (not shown), which can exhibit any suitable size, format, or dimensionality, and which can binomially, multinomially, discretely, or continuously indicate if the objects 118 present hazards to passenger 106 (e.g., potential intruders). As even another non-limiting example, the objects 608 can comprise a movement indicator (not shown), which can exhibit any suitable size, format, or dimensionality, and which can binomially, multinomially, discretely, or continuously indicate if the objects 114 are moving, not moving, or capable of moving.

In any case, the detection component 310 can execute the AI model 502 on the vicinity data 318, thereby yielding the objects 608.

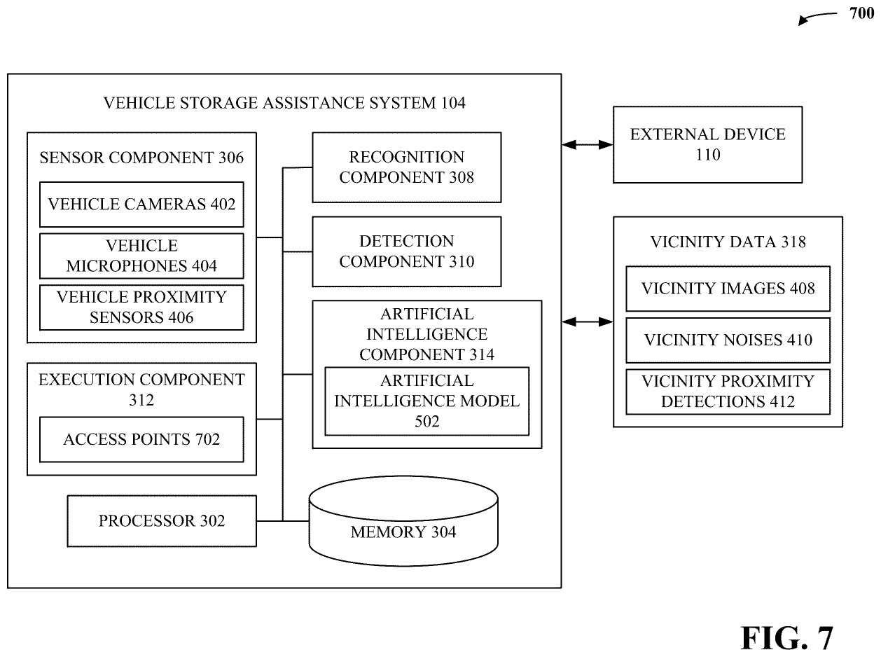

FIG. 7 illustrates a block diagram of an example, non-limiting system that can facilitate artificially intelligent vehicle storage assistance in accordance with one or more embodiments described herein. As shown, the system 700 can, in some cases, comprise the same components as the system 500, and can further comprise access points 702.

In various embodiments, the execution component 312 can electronically determine access points 702 to open, based on the objects 602 and objects 608. In various aspects, the AI model 502, the AI model 502 can be further configured to determine which access points on vehicle 102 to open based on the objects 108 that the passenger 106 is holding and the objects 114 around the vehicle 102. Accordingly, in response to detecting passenger 106 approaching vehicle 102 (e.g., via the various sensors, via detection of the external device 110 on passenger 106), the execution component 212 can execute the AI model 502 on the objects 602 and objects 608, thereby yielding access points 702.

For example, if the objects 602 indicate that passenger 106 is holding grocery bags that are small in size, and if the objects 608 indicate that there is a telephone pole in front of the trunk, the AI model 502 can generate a determination that the driver side rear door is suitable to open for storing the grocery bags. Accordingly, execution component 312 can control any suitable autonomous or electronically-controllable features to open the driver side rear door.

As another example, if the objects 602 indicate that passenger 106 is holding a child, and if the objects 608 indicate that there are no objects 608 around vehicle 102, the AI model 502 can generate a determination that the passenger side rear door is suitable to open for seating the child. Accordingly, execution component 312 can control any suitable autonomous or electronically-controllable features to open the passenger side rear door.

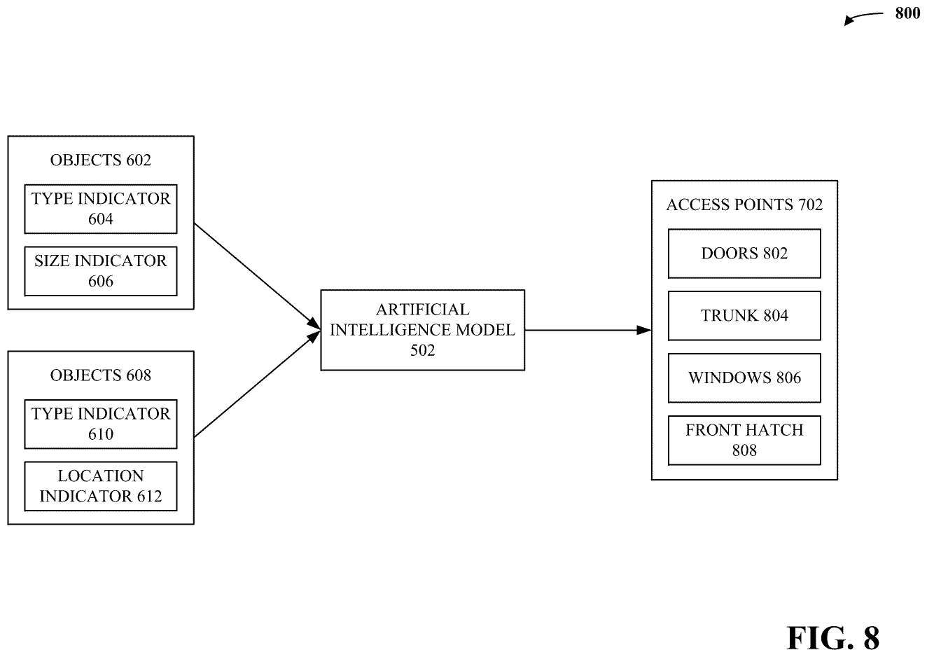

As yet another example, if the objects 602 indicate that passenger 106 is holding a child and a medium-sized box, and if the objects 608 indicate that there is a ceiling causing limited vertical clearance to open the trunk, the AI model 502 can generate a determination that the passenger side and driver side rear doors are suitable to open for seating the child and storing the medium-sized box. Accordingly, execution component 312 can control any suitable autonomous or electronically-controllable features to open the passenger side and driver side rear doors. Various non-limiting aspects are described with respect to FIG. 8.

In various embodiments, the execution component 312 can open access points 702 based on commands from the passenger 106. For instance, the external device 110 can receive audio commands from passenger 106, and transmit the audio commands to the vehicle 102 via the communication link 112. As a non-limiting example, the passenger 106 can specify that they desire the trunk to be opened. Accordingly, the execution component 312 can open the trunk as the passenger 106 approaches vehicle 102.

FIG. 8 illustrates an example, non-limiting block diagram 800 showing how AI model 502 can determine access points 702 to open in accordance with one or more embodiments described herein.

As shown, in various embodiments, the execution component 312 can execute the AI model 502 on the objects 602 and objects 608, thereby yielding access points 702. That is, based on the type or size of objects 108 that passenger 106 is holding, and based on the type and location of objects 114 around vehicle 102, the AI model 502 can determine which access points on vehicle 102 are suitable to open (e.g., safe to open without causing property damage or personal injury) to provide automated assistance to passenger 106. More specifically, the execution component 312 can feed the objects 602 and objects 608 (e.g., the type indicators 604, the size indicators 606, the type indicators 610, the location indicators 612) to an input layer of the AI model 502. In various instances, the objects 602 and objects 608 can complete a forward pass through one or more hidden layers of the AI model 502. In various cases, an output layer of the AI model 502 can compute the access points 702, based on activation maps or intermediate features produced by the one or more hidden layers.

In various aspects, access points 702 can be any suitable electronic data exhibiting any suitable format, size, or dimensionality. That is, the access points 702 can be one or more scalars, one or more vectors, one or more matrices, one or more tensors, one or more character strings, or any suitable combination thereof. In various instances, access points 702 can indicate, specify, convey, or otherwise represent any suitable characteristics, attributes, or properties of access points available on vehicle 102 that the AI model 502 deems suitable to open based on objects 602 and objects 608.

In various aspects, as shown, access points 702 can comprise indicators for various access points on vehicle 102. For example, access points 702 can comprise an indicator for doors 802 (e.g., any door on vehicle 102). In various instances, the doors 802 can have any suitable format, size, or dimensionality. That is, the doors 802 can be one or more scalars, one or more vectors, one or more matrices, one or more tensors, one or more character strings, or any suitable combination thereof. In any case, the doors 802 can indicate, convey, or otherwise represent which one or more doors on vehicle 102 are suitable to open. For instance, the objects 602 can indicate that passenger 106 is holding various objects, and the AI model 502 can be trained or otherwise configured, as described herein, to determine, based on the objects 602, which doors to open. In other words, if passenger 106 is detected to be holding objects 108, some manifestation of the type or size of objects 108 can be conveyed in the objects 602, and the AI model 502 can recognize such manifestation of the objects 108. In any case, the doors 802 can represent the determination, inference, or conclusion generated by the AI model 502 with respect to which doors on vehicle 102 to open based on the objects 108 that passenger 106 is holding and the objects 114 around vehicle 102.

As a non-limiting example, the indicator for doors 802 can be a multinomial variable that can take on one or more possible discrete states. In such case, the one or more possible discrete states can respectively represent a safe to open indicator for each door on vehicle 102. For instance, the indicator for doors 802 can have a “rear driver side door” state, a “rear passenger side door” state, a “front passenger door” state, or a “driver door” state. Thus, for example, if the AI model 502 deems that the front passenger door and the driver door are suitable to open, the doors 802 can flag, activate, or otherwise take on the “front passenger door” state and the “driver door” state. As another non-limiting example, the indicator for doors 802 can be any suitable binary or binomial variable that can take on one of two discrete states. In such case, the one of two possible discrete states can respectively represent if any of the doors on vehicle 102 are suitable to open. For instance, the indicator for doors 802 can have an “open” state and a “do not open” state. Thus, for example, if the AI model 502 deems that no doors are suitable to open, the doors 802 can flag, activate, or otherwise take on the “do not open” state.

In various aspects, access points 702 can comprise an indicator for a trunk 804 (e.g., a rear hatch on vehicle 102). In various instances, the trunk 804 can have any suitable format, size, or dimensionality. That is, the trunk 804 can be one or more scalars, one or more vectors, one or more matrices, one or more tensors, one or more character strings, or any suitable combination thereof. In any case, the trunk 804 can indicate, convey, or otherwise represent if the trunk on vehicle 102 is suitable to open. For instance, the objects 602 can indicate that passenger 106 is holding various objects and objects 608 can indicate there are objects around vehicle 102, and the AI model 502 can be trained or otherwise configured, as described herein, to determine, based on the objects 602 and objects 608, if the trunk is suitable to open. In other words, if passenger 106 is detected to be holding objects 108, some manifestation of the type or size of objects 108 can be conveyed in the objects 602 and some manifestation of the type or location of objects 114 can be conveyed in the objects 614, and the AI model 502 can recognize such manifestation of the objects 108 and objects 114. In any case, the trunk 804 can represent the determination, inference, or conclusion generated by the AI model 502 with respect to if the trunk is suitable to open based on the objects 108 that passenger 106 is holding and the objects 114 around vehicle 102.

As a non-limiting example, the indicator for trunk 804 can be any suitable binary or binomial variable that can take on one of two discrete states. In such case, the one of two possible discrete states can respectively represent if the trunk on vehicle 102 is suitable to open. For instance, the indicator for trunk 804 can have an “open” state and a “do not open” state. Thus, for example, if the AI model 502 deems that the trunk is not suitable to open, the trunk 804 can flag, activate, or otherwise take on the “do not open” state.

In various aspects, access points 702 can comprise an indicator for windows 806 (e.g., any window on vehicle 102). In various instances, the windows 806 can have any suitable format, size, or dimensionality. That is, the windows 806 can be one or more scalars, one or more vectors, one or more matrices, one or more tensors, one or more character strings, or any suitable combination thereof. In any case, the windows 806 can indicate, convey, or otherwise represent which one or more windows on vehicle 102 are suitable to open. For instance, the objects 602 can indicate that passenger 106 is holding various objects, and the AI model 502 can be trained or otherwise configured, as described herein, to determine, based on the objects 602, which windows to open. In other words, if passenger 106 is detected to be holding objects 108, some manifestation of the type or size of objects 108 can be conveyed in the objects 602, and the AI model 502 can recognize such manifestation of the objects 108. In any case, the windows 806 can represent the determination, inference, or conclusion generated by the AI model 502 with respect to which windows on vehicle 102 to open based on the objects 108 that passenger 106 is holding and the objects 114 around vehicle 102.

As a non-limiting example, the indicator for windows 806 can be a multinomial variable that can take on one or more possible discrete states. In such case, the one or more possible discrete states can respectively represent a safe to open indicator for each window on vehicle 102. For instance, the indicator for windows 806 can have a “rear driver side window” state, a “rear passenger side window” state, a “front passenger window” state, or a “driver window” state. Thus, for example, if the AI model 502 deems that the front passenger window and the driver window are suitable to open, the windows 806 can flag, activate, or otherwise take on the “front passenger window” state and the “driver window” state. As another non-limiting example, the indicator for windows 806 can be any suitable binary or binomial variable that can take on one of two discrete states. In such case, the one of two possible discrete states can respectively represent if any of the windows on vehicle 102 are suitable to open. For instance, the indicator for windows 806 can have an “open” state and a “do not open” state. Thus, for example, if the AI model 502 deems that no windows are suitable to open, the windows 806 can flag, activate, or otherwise take on the “do not open” state.

In various aspects, access points 702 can comprise an indicator for a front hatch 808 (e.g., a rear hatch on vehicle 102). In various instances, the front hatch 808 can have any suitable format, size, or dimensionality. That is, the front hatch 808 can be one or more scalars, one or more vectors, one or more matrices, one or more tensors, one or more character strings, or any suitable combination thereof. In any case, the front hatch 808 can indicate, convey, or otherwise represent if the trunk on vehicle 102 is suitable to open. For instance, the objects 602 can indicate that passenger 106 is holding various objects and objects 608 can indicate there are objects around vehicle 102, and the AI model 502 can be trained or otherwise configured, as described herein, to determine, based on the objects 602 and objects 608, if the trunk is suitable to open. In other words, if passenger 106 is detected to be holding objects 108, some manifestation of the type or size of objects 108 can be conveyed in the objects 602 and some manifestation of the type or location of objects 114 can be conveyed in the objects 614, and the AI model 502 can recognize such manifestation of the objects 108 and objects 114. In any case, the front hatch 808 can represent the determination, inference, or conclusion generated by the AI model 502 with respect to if the trunk is suitable to open based on the objects 108 that passenger 106 is holding and the objects 114 around vehicle 102.

As a non-limiting example, the indicator for front hatch 808 can be any suitable binary or binomial variable that can take on one of two discrete states. In such case, the one of two possible discrete states can respectively represent if the trunk on vehicle 102 is suitable to open. For instance, the indicator for front hatch 808 can have an “open” state and a “do not open” state. Thus, for example, if the AI model 502 deems that the trunk is not suitable to open, the front hatch 808 can flag, activate, or otherwise take on the “do not open” state.

Although not explicitly shown in FIG. 6, the access points 702 can comprise any other suitable indicators. As a non-limiting example, the access points 702 can comprise an indicator for a sunroof on vehicle 102 (not shown), which can exhibit any suitable size, format, or dimensionality, and which can binomially, multinomially, discretely, or continuously indicate whether the sunroof is suitable to open (as deemed by the AI model 502). As another non-limiting example, the access points 702 can comprise an indicator for a truck tailgate on vehicle 102 (not shown), which can exhibit any suitable size, format, or dimensionality, and which can binomially, multinomially, discretely, or continuously indicate whether the truck tailgate is suitable to open (as deemed by the AI model 502).

In any case, the detection component 310 can execute the AI model 502 on the objects 602 and objects 608, thereby yielding the access points 702 that indicate which access points on vehicle 102 are suitable to open. In this way, the AI model 502 can determine which access points are closest to passenger 106, and are not limited (e.g., blocked, hindered) by external objects 114.

In various embodiments, the sensor component 306 can comprise various sensors that face internally in the vehicle 102. For instance, the vehicle 102 can be equipped with various sensors within the vehicle that can monitor objects within the vehicle 102. As a non-limiting example, via the various sensors, the detection component 310 can detect if one or more seats, the trunk, or any other area within vehicle 102 contain objects (e.g., objects that limit space for objects 108 that passenger 106 is holding). In such instances, the AI model 502 can further receive the objects detected within vehicle 102 as input to determine the access points 702 as output.

As a non-limiting example, the detection component 310 can detect that passenger 106 is holding a large box. However, the detection component 310 can also detect, via the various sensors within vehicle 102, that the trunk is full. Accordingly, the AI model 502 can determine that the rear doors are suitable to open as opposed to the trunk, due to the limited space in the trunk. As another non-limiting example, the detection component 310 can detect that passenger 106 is holding some small bags. However, the detection component 310 can also detect, via the various sensors within vehicle 102, that the seat corresponding to the driver side rear door has a car seat. Accordingly, the AI model 502 can determine that the trunk is suitable to open as opposed to the driver side rear door, due to the limited space caused by the car seat.

In this way, the detection component 310 can determine if the seat or trunk accessible by the closest access point to passenger 106 is full, and thus determine an alternative access point to open in response to a determination that the seat or trunk accessible by the closest access point is full (e.g., has limited capacity or space). Accordingly, the execution component 312 can open the alternative access point to enable adaptable storage assistance to passenger 106.

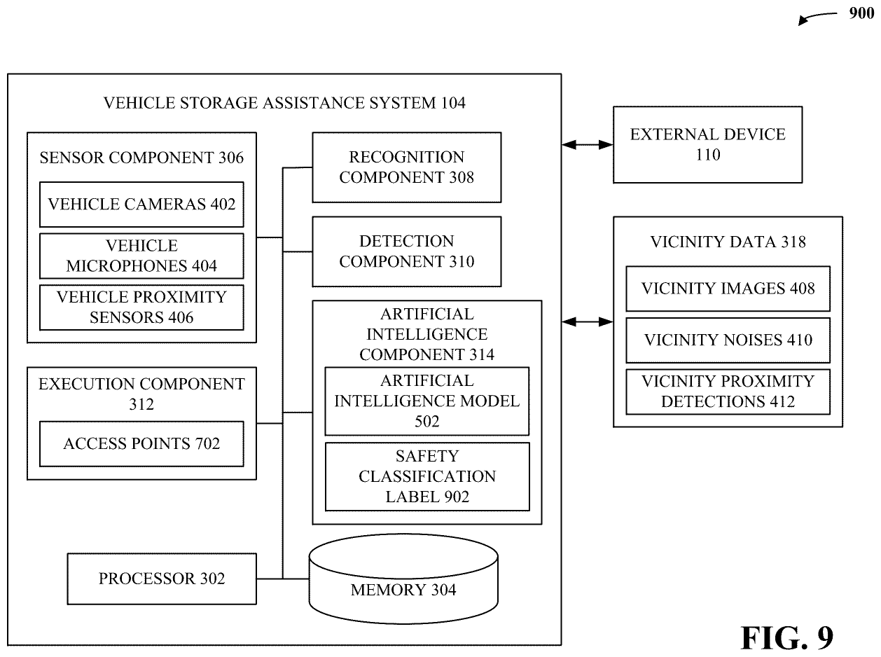

FIG. 9 illustrates a block diagram of an example, non-limiting system 900 including a safety classification label that can facilitate artificially intelligent vehicle storage assistance in accordance with one or more embodiments described herein. As shown, the system 900 can, in some cases, comprise the same components as the system 700, and can further comprise a safety classification label 902.

In various embodiments, the AI model 502 can be further configured to determine if it is safe to open access points 702 on vehicle 102 based on the objects 608 and vicinity data 318. Accordingly, the detection component 310 can electronically execute the AI model 502 on the objects 608 and the vicinity data 318, thereby yielding the safety classification label 902.

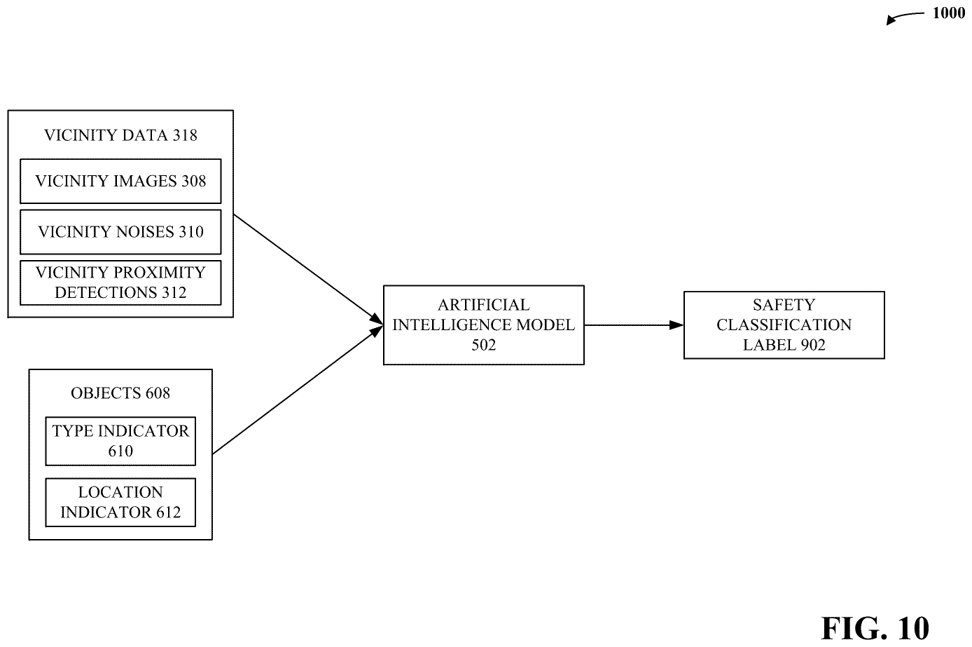

That is, in response to determining which access points on vehicle 102 are suitable to open to enable adaptable storage assistance to passenger 106, the detection component 310 can determine if the external environment is safe for opening the access points 702. As a non-limiting example, if there is pedestrian exhibiting suspicious behavior detected around the vehicle 102 as passenger 106 is approaching, the safety classification label 902 can indicate or convey that it is not safe to open any access points on vehicle 102 to prevent a potential break-in or theft. As another non-limiting example, if there is another vehicle detected circling around the vehicle 102, the safety classification label 902 can indicate or convey that it is not safe to open any access points on vehicle 102 to prevent a potential hostile situation. In any case, the detection component 310 can electronically execute the AI model 502 on the objects 608 and the vicinity data 318, thereby yielding the safety classification label 902. Various non-limiting aspects are described with respect to FIG. 10.

FIG. 10 illustrates an example, non-limiting block diagram 1000 showing how AI model 502 can generate the safety classification label 902 based on vicinity data 318 and objects 608 in accordance with one or more embodiments described herein.

As shown, the detection component 310 can, in various aspects, execute the AI model 502 on the vicinity data 318 and objects 608, and such execution can cause the AI model 502 to produce the safety classification label 902. More specifically, the detection component 310 can feed the vicinity data 318 (e.g., the set of vicinity images 408, the set of vicinity noises 410, or the set of vicinity proximity detections 412) and objects 608 (e.g., type indicators 610, location indicators 612) to an input layer of the AI model 502. In various instances, the vicinity data 318 and objects 608 can complete a forward pass through one or more hidden layers of the AI model 502. In various cases, an output layer of the AI model 502 can compute the safety classification label 902, based on activation maps or intermediate features produced by the one or more hidden layers.

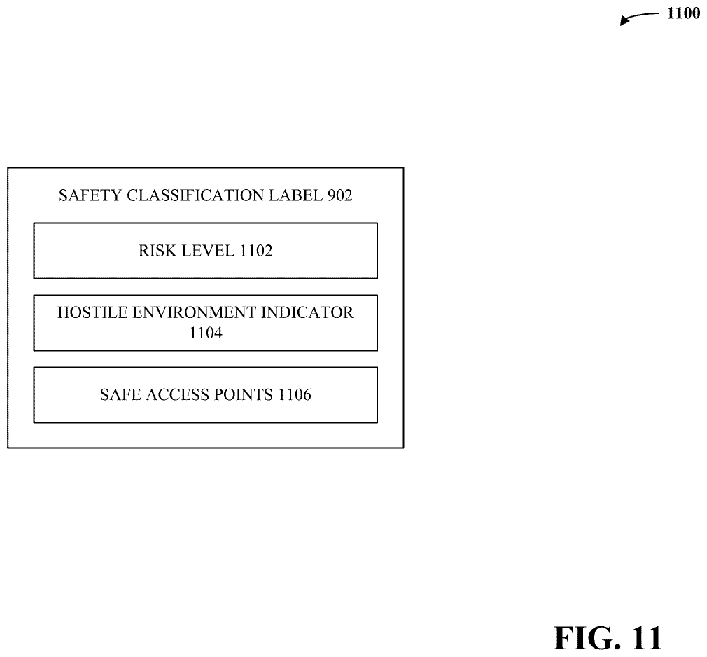

In various aspects, the safety classification label 902 can be any suitable electronic data exhibiting any suitable format, size, or dimensionality. That is, the safety classification label 902 can be one or more scalars, one or more vectors, one or more matrices, one or more tensors, one or more character strings, or any suitable combination thereof. In various instances, the safety classification label 902 can indicate, specify, convey, or otherwise represent whether it is safe to open access points 702 based on vicinity data 318 and objects 608 within vicinity 202. In some cases, if the safety classification label 902 indicates that it is not safe to open access points 702, then the safety classification label 902 can further indicate, specify, convey, or otherwise represent any suitable characteristics, attributes, or properties of such unsafe environment. Various non-limiting aspects are described with respect to FIG. 11.

FIG. 11 illustrates an example, non-limiting block diagram of the safety classification label 902 in accordance with one or more embodiments described herein.

In various aspects, as shown, the safety classification label 902 can comprise a risk level 1102. In various instances, the risk level 1102 can have any suitable format, size, or dimensionality. That is, the risk level 1102 can be one or more scalars, one or more vectors, one or more matrices, one or more tensors, one or more character strings, or any suitable combination thereof. In any case, the risk level 1102 can indicate, convey, or otherwise represent a level of risk present to passenger 106 for opening access points 702. For instance, the AI model 502 can be trained or otherwise configured, as described herein, to determine, based on the vicinity data 318 and objects 608, whether there is risk involved with opening the access points 702. In other words, if there is risk, some manifestation of such risk can be conveyed in the vicinity data 318 and objects 608, and the AI model 502 can recognize such manifestation of the risky environment. Conversely, if risk is present, no manifestation of such risk would be conveyed in the vicinity data 318 and objects 608, and the AI model 502 can recognize such lack of manifestation of risk. In any of these cases, the risk level 1102 can represent the determination, inference, or conclusion generated by the AI model 502 with respect to the level of risk present to passenger 106 for opening access points 702.

As a non-limiting example, the risk level 1102 can be a scalar whose magnitude (e.g., ranging continuously from 0 to 1) represents a likelihood or probability that there is or is not an unsafe environment (or that there is not an unsafe environment). As another non-limiting example, the risk level 1102 can be a multinomial variable that can take on one of three or more possible discrete states. In such case, the three or more possible discrete states can respectively represent any suitable level of risk. For instance, the risk level 1102 can have a “low risk” state, a “medium risk” state, or a “high risk” state.

In various aspects, as shown, the safety classification label 902 can comprise a risk level 1102. In various instances, the risk level 1102 can have any suitable format, size, or dimensionality. That is, the risk level 1102 can be one or more scalars, one or more vectors, one or more matrices, one or more tensors, one or more character strings, or any suitable combination thereof. In any case, the risk level 1102 can indicate, convey, or otherwise represent a presence or an absence of a hostile environment within vicinity 202. For instance, the AI model 502 can be trained or otherwise configured, as described herein, to determine, based on the vicinity data 318 and objects 608, whether there is a hostile environment as passenger 106 is approaching vehicle 102. In other words, if there is a hostile environment, some manifestation of such hostile environment can be conveyed in the vicinity data 318 (e.g., the hostile environment can be depicted in the set of vicinity images 408, distinctive sounds of the hostile environment can be captured in the set of vicinity noises 410, the hostile environment can cause a distinctive anomaly in the set of vicinity proximity detections 320) and objects 608, and the AI model 502 can recognize such manifestation of the hostile environment. Conversely, if no hostile environment is present, no manifestation of such hostile environment would be conveyed in the vicinity data 318 (e.g., no hostile environment would be depicted in the set of vicinity images 408, no distinctive sounds of a hostile environment would be captured in the set of vicinity noises 410, no distinctive anomalies of a hostile environment would be in the set of vicinity proximity detections 320) and objects 608, and the AI model 502 can recognize such lack of manifestation of a hostile environment. In any of these cases, the risk level 1102 can represent the determination, inference, or conclusion generated by the AI model 502 with respect to the presence or absence of a hostile environment.

As a non-limiting example, the risk level 1102 can be a binary or binomial variable; that is, a variable that can take on one of two possible discrete states. In such case, one of the two possible discrete states can represent a “hostile” state, whereas the other of the two possible discrete states can represent an “not hostile” state. That is, the risk level 1102 can take on the “present” state when the AI model 502 infers that there is a hostile environment within vicinity 202, and the risk level 1102 can take on the “absent” state when the AI model 502 instead infers that there is no hostile environment within vicinity 202.

In various aspects, as shown, the safety classification label 902 can comprise safe access points 1106. In various instances, the safe access points 1106 can have any suitable format, size, or dimensionality. That is, the safe access points 1106 can be one or more scalars, one or more vectors, one or more matrices, one or more tensors, one or more character strings, or any suitable combination thereof. In any case, the safe access points 1106 can indicate, convey, or otherwise represent which of access points 702 are safe to open. For instance, the AI model 502 can be trained or otherwise configured, as described herein, to determine, based on the vicinity data 318 and objects 608, whether it is safe to open each of the access points 702. In any of case, the safe access points 1106 can represent the determination, inference, or conclusion generated by the AI model 502 with respect to which of access points 702 are safe to open.

As a non-limiting example, the safe access points 1106 can be a multinomial variable that can take on one of three or more possible discrete states. In such case, the three or more possible discrete states can respectively represent any of the access points 702 that are safe to open. For instance, the safe access points 1106 can have a “doors” state, a “trunk” state, a “windows” state, or a “front hatch” state, or a “front hatch” state. Thus, the safe access points 1106 can select, from access points 702, which of the access points are safe to open based on the objects 608 and vicinity data 318. As a non-limiting example, the safe access points 1106 can be a multinomial variable that can take on one or more possible discrete states that index states of the access points 702. For instance, if access points 702 indicate that the driver door and passenger door are suitable to open to enable storage assistance to passenger 106, however, the safety classification label 902 indicates that there is a hostile object or person approaching from the passenger side, the safe access points 1106 can take on a “1” state to index the driver door, thus indicating that the driver door is safe to open but the passenger door is not safe to open.

Although not explicitly shown in FIG. 11, the safety classification label 902 can comprise any other suitable indicators. As a non-limiting example, the safety classification label 902 can comprise an indicator for a direction from vehicle 102 that the hostile environment is present.

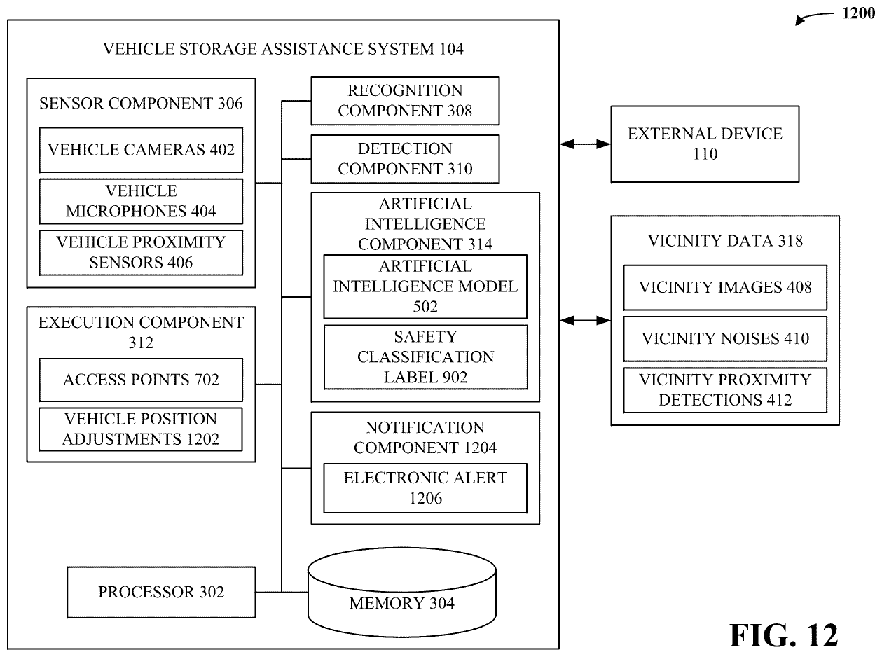

FIG. 12 illustrates a block diagram of an example, non-limiting system 1200 including vehicle position adjustments, a notification component and an electronic alert that can facilitate artificially intelligent vehicle storage assistance in accordance with one or more embodiments described herein. As shown, the system 1200 can, in some cases, comprise the same components as the system 900, and can further comprise vehicle operation adjustments 1202, a notification component 1204, and an electronic alert 1206.

In various embodiments, in response to the safety classification label 902 indicating that there is a hostile environment or an otherwise unsafe environment to open access points 702, the notification component 1204 can electronically generate the electronic alert 1206, based on the safety classification label 902. Accordingly, the notification component 1204 can transmit, via the communication link 112, the electronic alert 1206 to the external device 110, thus informing passenger 106. In this way, the vehicle 102 can be considered as informing or notifying the passenger 106 of the unsafe environment detected by the AI model 502.

In other instances, in response to the execution component 312 operating any autonomous or electronically-controllable features of vehicle 102, the notification component 1204 can electronically generate the electronic alert 1206 based on the vehicle operation adjustments 1202. More specifically, in various aspects, the execution component 312 can execute the AI model on the objects 602 and objects 608, thereby yielding vehicle operation adjustments 1202. That is, based on the objects 602 (e.g., type and size of objects 108) and objects 608 (e.g., type and location of objects 108), the AI model 502 can determine adjustments to operations of vehicle 102 that can enable opening of access points 702 without property damage or personal injury. For example, AI model 502 can determine that an adjustment to the position of vehicle 102 can enable opening of access points 702 without property damage or personal injury. Accordingly, the execution component 312 can operate any suitable autonomous or electronically-controllable features of vehicle 102 to facilitate such adjustment to the position of vehicle 102. As another example, AI model 502 can determine that opening an alternative access point to access points 702 can enable vehicle storage assistance without property damage or personal injury. Accordingly, the execution component 312 can operate any suitable autonomous or electronically-controllable features of vehicle 102 to facilitate opening of such alternative access point. In any case, the notification component 1204 can electronically generate the electronic alert 1206 based on the vehicle operation adjustments 1202. Accordingly, the notification component 1204 can transmit, via the communication link 112, the electronic alert 1206 to the external device 110, thus informing passenger 106. In this way, the vehicle 102 can be considered as informing or notifying the passenger 106 of any adjustments to operations of vehicle 102 to mitigate potential property damage or personal injuries.

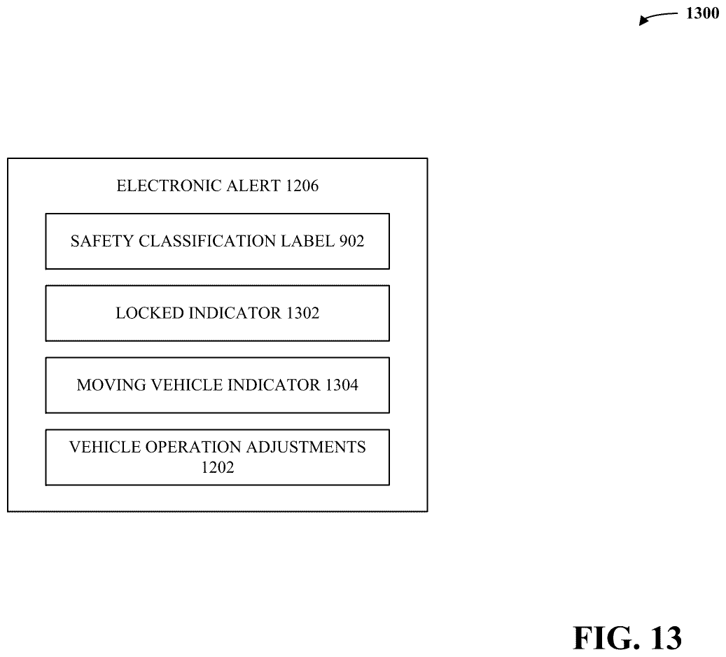

Various non-limiting details are described with respect to FIG. 13.

In various embodiments, the vehicle operation adjustments 1202 can comprise steering parameters. In various aspects, the steering parameters can include any suitable number of steering parameters. In various instances, a steering parameter can be any suitable electronic data (e.g., can be one or more scalars, one or more vectors, one or more matrices, one or more tensors, or one or more character strings) that can indicate an electronically-controllable or electronically-adjustable steering-related setting of the vehicle 102. As a non-limiting example, a steering parameter can identify a particular wheel of the vehicle 102, the steering parameter can further identify a principal axis of the particular wheel, and the parameter can even further identify a range of motion (e.g., an angular range) through which the particular wheel can controllably swivel or rotate about the principal axis for purposes of steering.

In various embodiments, the vehicle operation adjustments 1202 can comprise throttle parameters. In various aspects, the throttle parameters can include any suitable number of throttle parameters. In various instances, a throttle parameter can be any suitable electronic data (e.g., can be one or more scalars, one or more vectors, one or more matrices, one or more tensors, or one or more character strings) that can indicate an electronically-controllable or electronically-adjustable throttle-related setting of the vehicle 102. As a non-limiting example, a throttle parameter can identify a particular wheel of the vehicle 102, and the throttle parameter can further identify a speed range (e.g., from a maximum speed in one direction to a maximum speed in an opposite direction) at which the particular wheel can be controllably driven or rotated.

In various embodiments, the vehicle operation adjustments 1202 can comprise braking parameters. In various aspects, the braking parameters can include any suitable number of braking parameters. In various instances, a braking parameter can be any suitable electronic data (e.g., can be one or more scalars, one or more vectors, one or more matrices, one or more tensors, or one or more character strings) that can indicate an electronically-controllable or electronically-adjustable braking-related setting of the vehicle 102. As a non-limiting example, a braking parameter can identify a particular wheel of the vehicle 102, and the braking parameter can further identify a braking intensity range (e.g., from a minimum amount of brake application or compression force to a maximum amount of brake application or compression) which can be controllably imparted to the particular wheel.

In various embodiments, the vehicle operation adjustments 1202 can comprise access point parameters. In various aspects, the access point parameters can include any suitable number of access point parameters. In various instances, an access point parameter can be any suitable electronic data (e.g., can be one or more scalars, one or more vectors, one or more matrices, one or more tensors, or one or more character strings) that can indicate an electronically-controllable or electronically-adjustable access point setting of the vehicle 102. As a non-limiting example, an access point parameter can identify an angle for opening an access point of the vehicle 102 (e.g., a maximum angle to open the trunk, a maximum angle to open a door, a maximum angle to open a front hatch).

In any case, the execution component 312 can perform the vehicle operation adjustments 1202 according to the steering parameters, throttle parameters, braking parameters, or access point parameters.

In various embodiments, the AI model 502 can further determine vehicle operation adjustments 1202 based on the vicinity data 318. As a non-limiting example, the vicinity data 318 can indicate that the temperature outside the vehicle is hot and thus can generate any suitable commands to activate air conditioning within the vehicle. Accordingly, the execution component 312 can activate the air conditioning as the passenger 106 approaches the vehicle.

FIG. 13 illustrates an example, non-limiting block diagram 1300 of the electronic alert 1206 in accordance with one or more embodiments described herein.

In various embodiments, the electronic alert 1206 can comprise any suitable electronic data pertaining to the safety classification label 902 or the vehicle operation adjustments 1202 generated by the AI model 502. As a non-limiting example, the electronic alert 1206 can comprise the safety classification label 902. As another non-limiting example, the electronic alert 1206 can comprise the vehicle operation adjustments 1202.

As yet another non-limiting example, the electronic alert 1206 can comprise a locked indicator 1302. In various aspects, the locked indicator 1302 can be any suitable electronic data (e.g., can be one or more scalars, one or more vectors, one or more matrices, one or more tensors, one or more character strings, or any suitable combination thereof) that can indicate if the access points of vehicle 102 are locked. For instance, in response to the hostile environment indicator 1104 indicating that there is a hostile environment, the execution component 312 can lock all access points of vehicle 102. Accordingly, the locked indicator 1302 can indicate that the access points of vehicle 102 are locked (e.g., indicate that all access points are locked). Conversely, in response to the hostile environment indicator 1104 indicating that there is not a hostile environment, the execution component 312 can unlock access points 702 of vehicle 102. Accordingly, the locked indicator 1302 can indicate that the access points 702 of vehicle 102 are unlocked (e.g., indicate that the driver door and trunk are unlocked).

As still another non-limiting example, the electronic alert 1206 can comprise a moving vehicle indicator 1304. In various aspects, the moving vehicle indicator 1304 can be any suitable electronic data (e.g., can be one or more scalars, one or more vectors, one or more matrices, one or more tensors, one or more character strings, or any suitable combination thereof) that can indicate if the vehicle 102 is moving or is about to move. For instance, in response to the AI model 502 determining vehicle operation adjustments 1202, the execution component 312 can perform the vehicle operation adjustments 1202 (e.g., can adjust a position of the vehicle 102). Accordingly, the moving vehicle indicator 1304 can indicate that the vehicle 102 is in motion or will be in motion (e.g., indicate that the vehicle 102 is backing up, indicate that the vehicle 102 is turning, indicate that the vehicle 102 is moving forward). Conversely, in response to the AI model 502 determining that there are no vehicle operation adjustments 1202 needed to open access points 702, moving vehicle indicator 1304 can indicate that the vehicle 102 is not in motion and will not be in motion. In this way, the vehicle 102 can be considered as informing or notifying the passenger 106 of any adjustments to operations of vehicle 102 to mitigate potential property damage or personal injuries (e.g., prevent passenger 106 from walking behind vehicle 102 as the position of the vehicle is being adjusted).

In other instances, the moving vehicle indicator 1304 can indicate that the vehicle 102 is in motion when any of the access points 702 are opened by execution component 312. That is, regardless of if the AI model 502 detects a hostile environment, the notification component 1204 can generate electronic alert 1206 where the moving vehicle indicator 1304 indicates that the access points 702 are opening. Accordingly, the notification component 1204 can transmit the electronic alert 1206 to the external device 110 via the communication link 112. In this way, the vehicle 102 can be considered as informing or notifying the passenger 106 that the access points 702 are open or will open.

Although not explicitly shown in the figures, the electronic alert 1206 can comprise any suitable data to inform passenger 106 of a hostile environment or performance of vehicle operation adjustments. As a non-limiting example, the electronic alert 1206 can comprise the vicinity data 318 (or any suitable portion thereof). That is, the electronic alert 1206 can contain whatever raw data was recorded, measured, or otherwise captured by the sensor component 306 and on the basis of which the AI model 502 detected a hostile environment (e.g., the electronic alert 1206 can contain the set of vicinity images 408, the set of vicinity noises 410, or the set of vicinity proximity detections 412).

In various embodiments, since the passenger 106 may have their hands occupied, the external device 110 can be equipped with any suitable audio speaker. Thus, in response to transmitting the electronic alert 1206, the external device 110 can play, via the audio speaker, an audible alert to notify passenger 106 that there is a hostile environment, that the vehicle 102 is in motion, or that the access points 702 have been opened.

In any case, the notification component 1204 can generate the electronic alert 1206, and the notification component 214 can transmit the electronic alert 1206 to the external device 110 via the communication link 112.

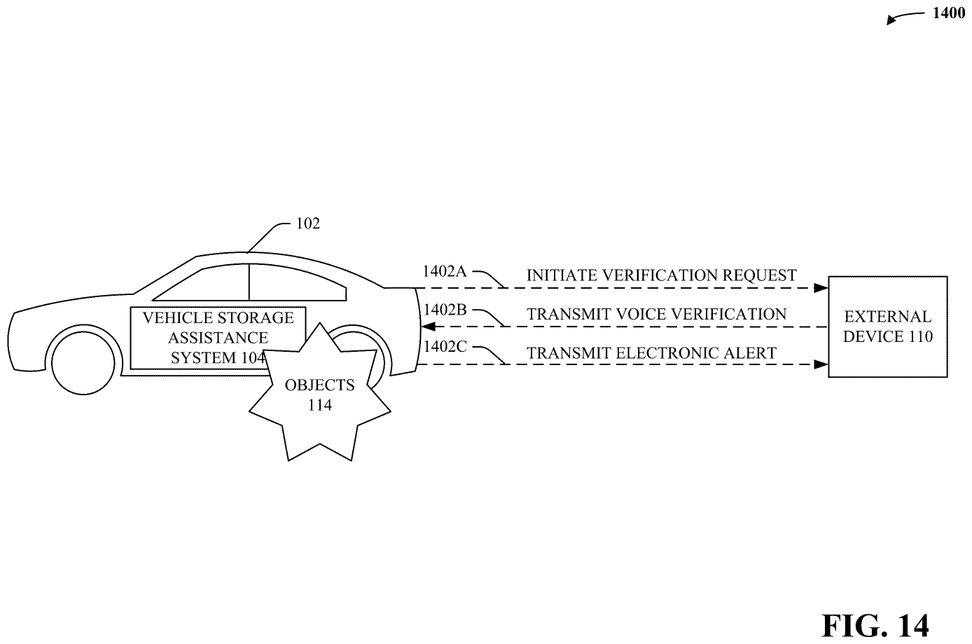

FIG. 14 illustrates an example, non-limiting block diagram showing communication between an external device and a vehicle that can facilitate artificially intelligent vehicle storage assistance in accordance with one or more embodiments described herein.

In particular, FIG. 14 illustrates a non-limiting example of a communication flow between the vehicle 102 and the external device 110. In such non-limiting example, the recognition component 308 can detect passenger 106 approaching vehicle 102. For instance, the recognition component 308 can detect that passenger 106 is within vicinity 202 of vehicle 102 based on a location of external device 110. In other instances, the recognition component 308 can detect that passenger 106 is within vicinity 202 based on the various sensors of vehicle 102 and vicinity data 318. In either case, the recognition component 308 can verify identity of the passenger 106. To verify the identity of the passenger 106, at 1402A, the vehicle 102 can transmit a verification request to the external device 110 via communication link 112.

Thereafter, external device 110 can receive audio verification from passenger 106. For instance, the external device 110 can be equipped with any suitable microphones. Thus, the passenger 106 can provide audio input to external device 110 via the microphones, and the external device 110 can, at 1402B, transmit the audio input to vehicle 102. That is, the external device 110 can transmit a voice verification to the vehicle 102. Then, based on the audio input received from external device 110, the vehicle 102 can verify the audio input. As a non-limiting example, the recognition component 308 can match, using any suitable method, the audio input to prerecorded audio input previously provided by passenger 106.

Thus, in response to verifying the identity of passenger 106 based on the audio input, the notification component 1204 can generate electronic alert 1206 and transmit, at 1402C, the electronic alert 1206 to the external device 110 to notify passenger 106 that their identity has been verified. Conversely, in response to not verifying the identity of passenger 106 based on the audio input (e.g., the audio input does not match), the execution component 312 can, for instance, lock all access points of vehicle 102. If the vehicle 102 is coupled, via any suitable communication link, with a secondary external device, such as a mobile phone of passenger 106, then the notification component 1204 can generate the electronic alert 1206 and transmit the electronic alert 1206 to the secondary external device.

Although not shown, alternatively to verifying identity via audio recognition, the external device 110 can receive facial verification from passenger 106. For instance, the external device 110 can be equipped with any suitable cameras. Thus, the passenger 106 can provide visual input (e.g., images, videos) to external device 110 via the cameras, and the external device 110 can, at 1402B, transmit the visual input to vehicle 102. That is, the external device 110 can transmit a facial verification to the vehicle 102. Then, based on the visual input received from external device 110, the vehicle 102 can verify the visual input (e.g., verify an image or video of passenger 106). As a non-limiting example, the recognition component 308 can match, using any suitable method, the visual input to stored images or videos of passenger 106 previously provided by passenger 106.

In either case, the vehicle 102 can be considered as verifying the identity of passenger 106 via audio recognition or facial recognition.

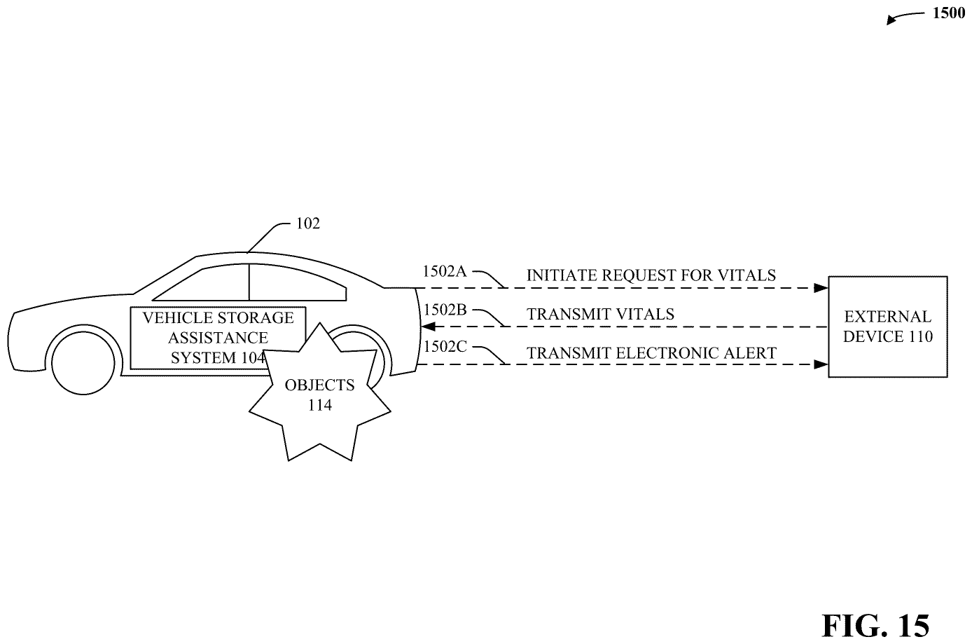

FIG. 15 illustrates another example, non-limiting block diagram 1500 showing communication between the external device 110 and the vehicle 102 that can facilitate artificially intelligent vehicle storage assistance in accordance with one or more embodiments described herein.

In particular, FIG. 15 illustrates a non-limiting example of a communication flow between the vehicle 102 and the external device 110. In such non-limiting example, the safety classification label 902 can indicate that there is a probability that there may be a hostile environment (e.g., a medium risk level, a high risk level). In such scenario, to determine if there is a hostile environment, the detection component 310 can transmit, at 1502A, a request for vitals to external device 110 via communication link 112. For instance, the external device 110 can be equipped with any suitable vital obtaining features (e.g., a heart rate monitor, location tracking). As a non-limiting example, the external device 110 can be a smart phone that can monitor the heart rate of passenger 106.

In any case, the external device 110 can collect the vital information from passenger 106, and transmit, at 1502B, the vital information to the vehicle 102 via communication link 112. Thereafter, based on the vital information, the vehicle 102 can determine if there is a hostile environment. For instance, the AI model 502 can be configured to generate (or modify) the safety classification label 902 based on the vital information of passenger 106. As a non-limiting example, if the vital information indicates that the passenger has an abnormally higher heart rate than their resting heart rate, the AI model 502 can determine that there is a hostile environment.

In any case, based on the determination that there is a hostile environment, the notification component 1204 can generate electronic alert 1206 where the hostile environment indicator 1104 is flagged (e.g., indicates there is a hostile environment). In other instances, based on the determination that there is not a hostile environment, the notification component 1204 can generate electronic alert 1206 where the hostile environment indicator 1104 is not flagged (e.g., indicates there is not a hostile environment). In any instance, the notification component 1204 can transmit, at 1502C, the electronic alert 1206 to external device 110 via communication link 112, informing the passenger 106 that there is or is not a hostile environment.

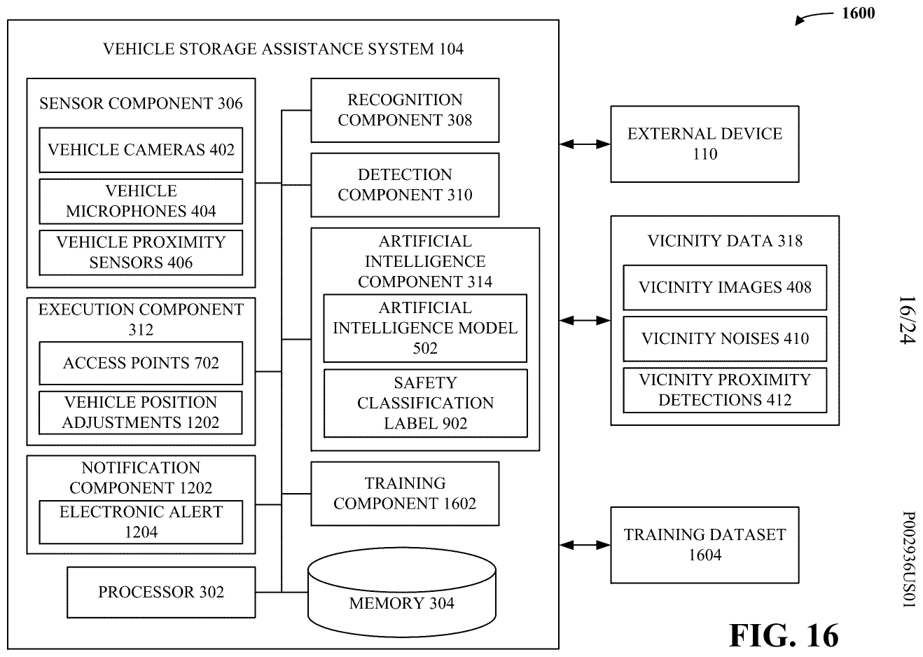

To help ensure that identification of objects 602, identification of objects 608, determination of access points 702, and generation of safety classification label 902 is accurate, the AI model 502 can first undergo training. Various non-limiting aspects of such training are described with respect to FIGS. 16-18.

FIG. 16 illustrates a block diagram of an example, non-limiting system 1600 including a training component and a training dataset that can facilitate artificially intelligent vehicle storage assistance in accordance with one or more embodiments described herein. As shown, the system 1600 can, in some cases, comprise the same components as the system 1200, and can further comprise a training component 1602 or a training dataset 1604.

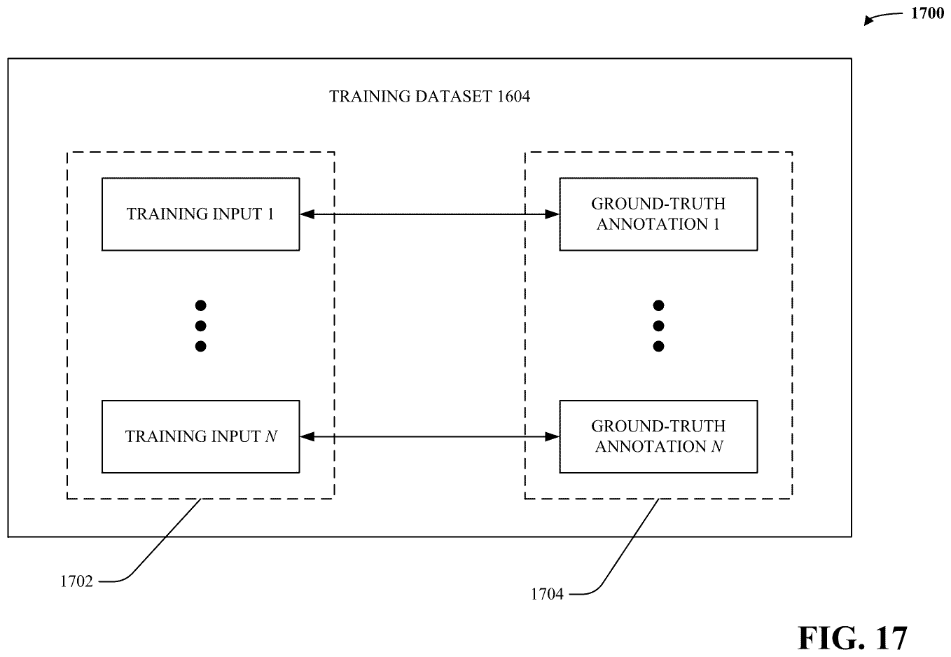

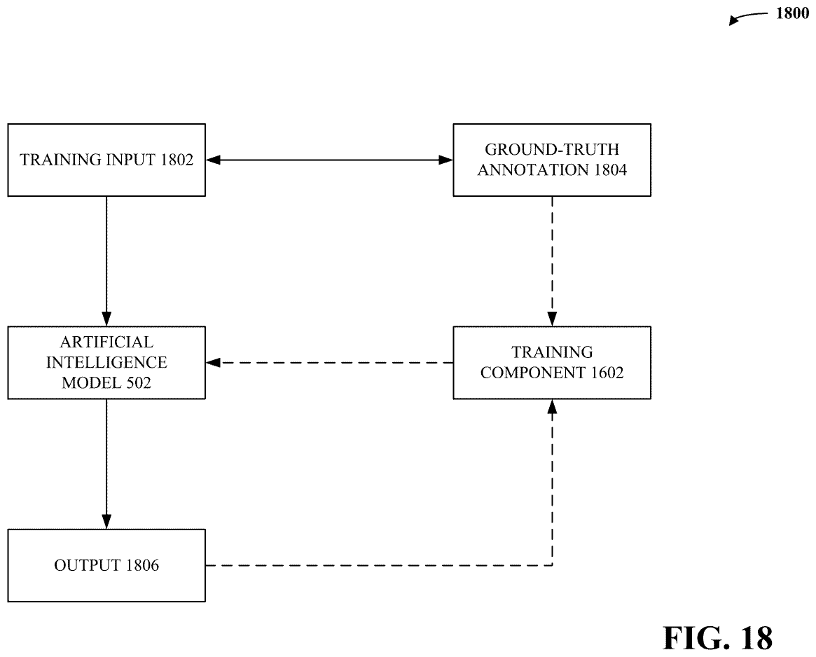

In various aspects, the training component 1602 can electronically receive, retrieve, obtain, or otherwise access, from any suitable source, the training dataset 1604. In various aspects, the training component 1602 can train the AI model 502 based on the training dataset 1604. Various non-limiting aspects are described with respect to FIGS. 17 and 18.

FIG. 17 illustrates an example, non-limiting block diagram 1700 of the training dataset 1604 in accordance with one or more embodiments described herein. As shown, the training dataset 1604 can, in various aspects, comprise a set of training inputs 1702 and a set of ground-truth annotations 1704.

In various embodiments, to train AI model 502 to detect objects 602 and objects 608, the following training dataset can be utilized.

In various aspects, the set of training inputs 1002 can include n inputs for any suitable positive integer n: a training input 1 to a training input n. In various instances, a training input can be any suitable electronic data having the same format, size, or dimensionality as the vicinity data 318. In other words, each training input can be raw data captured by sensors of a vehicle that were monitoring a respective vehicle vicinity. For example, the training input 1 can include a first set of training vicinity images depicting portions of a first vehicle vicinity, a first set of training vicinity noises that occurred in those portions of the first vehicle vicinity, a first set of training vicinity temperatures associated with those portions of the first vehicle vicinity, a first set of training vicinity humidities associated with those portions of the first vehicle vicinity, or a first set of training vicinity proximity detections associated with those portions of the first vehicle vicinity. Likewise, as another example, the training input n can include an n-th set of training vicinity images depicting portions of an n-th vehicle vicinity, an n-th set of training vicinity noises that occurred in those portions of the n-th vehicle vicinity, an n-th set of training vicinity temperatures associated with those portions of the n-th vehicle vicinity, an n-th set of training vicinity humidities associated with those portions of the n-th vehicle vicinity, or an n-th set of training vicinity proximity detections associated with those portions of the n-th vehicle vicinity.

In various aspects, the set of ground-truth annotations 1004 can respectively correspond (e.g., in one-to-one fashion) to the set of training inputs 1002. Thus, since the set of training inputs 1002 can have n inputs, the set of ground-truth annotations 1004 can have n annotations: a ground-truth annotation 1 to a ground-truth annotation n. In various instances, each of the set of ground-truth annotations 1004 can have the same format, size, or dimensionality as the objects 602 and objects 608. That is, each ground-truth annotation can be any suitable electronic data that indicates or represents a presence or other attributes (e.g., type, size, location) of objects held by a vehicle passenger or objects around a vehicle that is known or deemed to be manifested in a respective training input. For example, the ground-truth annotation 1 can correspond to the training input 1. Accordingly, the ground-truth annotation 1 can be considered as the correct or accurate object identification that indicates the presence or other attributes of whatever objects held by a vehicle passenger or objects around a vehicle is known or deemed to be manifested in the training input 1. As another example, the ground-truth annotation n can correspond to the training input n. Accordingly, the ground-truth annotation n can be considered as the correct or accurate object identification that indicates the presence or other attributes of whatever objects held by a vehicle passenger or objects around a vehicle is known or deemed to be manifested in the training input n.

In various embodiments, to train AI model 502 to determine access points 702, the following training dataset can be utilized.

In various aspects, the set of training inputs 1002 can include n inputs for any suitable positive integer n: a training input 1 to a training input n. In various instances, a training input can be any suitable electronic data having the same format, size, or dimensionality as the objects 602 and objects 608. In other words, each training input can be detected objects that a passenger is holding or detected external objects around a vehicle. For example, the training input 1 can include a first set of training objects where the objects are children, a first set of training objects where the objects are personal items, a first set of training objects where the objects are boxes, a first set of training objects where the objects are grocery bags, a first set of training objects where the objects comprise a small size, a first set of training objects where the objects comprise a medium size, or a first set of training objects where the objects comprise a large size. Likewise, as another example, the training input n can include an n-th set of training objects where the objects are children, an n-th set of training objects where the objects are personal items, an n-th set of training objects where the objects are boxes, an n-th set of training objects where the objects are grocery bags, an n-th set of training objects where the objects comprise a small size, an n-th set of training objects where the objects comprise a medium size, or an n-th set of training objects where the objects comprise a large size.

Furthermore, the training input 1 can include a first set of training objects where the external objects are poles, a first set of training objects where the external objects are vehicles, a first set of training objects where the external objects are pedestrians, a first set of training objects where the external objects are barriers, a first set of training objects where the external objects are moveable obstructions, a first set of training objects where the external objects are located in front of the vehicle, a first set of training objects where the external objects are located behind the vehicle, or a first set of training objects where the external objects are located next to the vehicle. Likewise, as another example, the training input n can include an n-th set of training objects where the external objects are poles, an n-th set of training objects where the external objects are vehicles, an n-th set of training objects where the external objects are pedestrians, an n-th set of training objects where the external objects are barriers, an n-th set of training objects where the external objects are moveable obstructions, an n-th set of training objects where the external objects are located in front of the vehicle, an n-th set of training objects where the external objects are located behind the vehicle, or an n-th set of training objects where the external objects are located next to the vehicle.

In various aspects, the set of ground-truth annotations 1004 can respectively correspond (e.g., in one-to-one fashion) to the set of training inputs 1002. Thus, since the set of training inputs 1002 can have n inputs, the set of ground-truth annotations 1004 can have n annotations: a ground-truth annotation 1 to a ground-truth annotation n. In various instances, each of the set of ground-truth annotations 1004 can have the same format, size, or dimensionality as the access points 702. That is, each ground-truth annotation can be any suitable electronic data that indicates or represents a presence or other attributes (e.g., door, windows, trunk, front hatch) of suitable access points of the vehicle that is known or deemed to be manifested in a respective training input. For example, the ground-truth annotation 1 can correspond to the training input 1. Accordingly, the ground-truth annotation 1 can be considered as the correct or accurate suitable access points of the vehicle that is known or deemed to be manifested in the training input 1. As another example, the ground-truth annotation n can correspond to the training input n. Accordingly, the ground-truth annotation n can be considered as the correct or accurate suitable access points of the vehicle that is known or deemed to be manifested in the training input n.

In various embodiments, to train AI model 502 to generate safety classification label 902, the following training dataset can be utilized.

In various aspects, the set of ground-truth annotations 1004 can respectively correspond (e.g., in one-to-one fashion) to the set of training inputs 1002. Thus, since the set of training inputs 1002 can have n inputs, the set of ground-truth annotations 1004 can have n annotations: a ground-truth annotation 1 to a ground-truth annotation n. In various instances, each of the set of ground-truth annotations 1004 can have the same format, size, or dimensionality as the safety classification label 902. That is, each ground-truth annotation can be any suitable electronic data that indicates or represents a presence or other attributes (e.g., hostile environment, risk level, safe access points) of an environment within vicinity 202 and suitable access points that is known or deemed to be manifested in a respective training input. For example, the ground-truth annotation 1 can correspond to the training input 1. Accordingly, the ground-truth annotation 1 can be considered as the correct or accurate classification label that indicates the presence or other attributes of whatever environment within vicinity 202 and suitable access points is known or deemed to be manifested in the training input 1. As another example, the ground-truth annotation n can correspond to the training input n. Accordingly, the ground-truth annotation n can be considered as the correct or accurate classification label that indicates the presence or other attributes of whatever environment within vicinity 202 and suitable access points is known or deemed to be manifested in the training input n.

Now, consider FIG. 18. FIG. 18 illustrates an example, non-limiting block diagram 1800 showing how the AI model 502 can be trained in accordance with one or more embodiments described herein.

In various aspects, the training component 1602 can, prior to beginning training, initialize in any suitable fashion (e.g., random initialization) the trainable internal parameters (e.g., convolutional kernels, weight matrices, bias values) of the AI model 502.

In various aspects, the training component 1602 can select, from the training dataset 1604, a training input 1802 and a ground-truth annotation 1804 corresponding to the training input 1802. In various instances, the training component 1602 can execute the AI model 502 on the training input 1802, thereby causing the AI model 502 to produce an output 1806. More specifically, in some cases, an input layer of the AI model 502 can receive the training input 1802, the training input 1802 can complete a forward pass through one or more hidden layers of the AI model 502, and an output layer of the AI model 502 can compute the output 1806 based on activation maps or intermediate features provided by the one or more hidden layers.

In various aspects, to train AI model 502 to detect objects 602 and objects 608, the output 1806 can be considered as the predicted or inferred object identification (e.g., as the predicted/inferred object types, the predicted/inferred object sizes, the predicted/inferred object locations) that the AI model 502 believes should correspond to the training input 1802. In contrast, the ground-truth annotation 1804 can be considered as the correct/accurate object identification (e.g., as the correct/accurate object types, the correct/accurate object sizes, the correct/accurate object locations) that is known or deemed to correspond to the training input 1802. Note that, if the AI model 502 has so far undergone no or little training, then the output 1806 can be highly inaccurate. In other words, the output 1806 can be very different from the ground-truth annotation 1804.

In various aspects, to train AI model 502 to determine access points 702, the output 1806 can be considered as the predicted or inferred suitable access points (e.g., as the predicted/inferred suitable doors to open, the predicted/inferred suitable windows to open, the predicted/inferred trunk indicator, the predicted/inferred front hatch indicator) that the AI model 502 believes should correspond to the training input 1802. In contrast, the ground-truth annotation 1804 can be considered as the correct/accurate suitable access points (e.g., as the correct/accurate suitable doors to open, the correct/accurate suitable windows to open, the correct/accurate trunk indicator, the correct/accurate front hatch indicator) that is known or deemed to correspond to the training input 1802. Note that, if the AI model 502 has so far undergone no or little training, then the output 1806 can be highly inaccurate. In other words, the output 1806 can be very different from the ground-truth annotation 1804.

In various aspects, to train AI model 502 to generate safety classification label 902, the output 1806 can be considered as the predicted or inferred safety classification label (e.g., as the predicted/inferred risk level, the predicted/inferred suitable hostile environment indicator, the predicted/inferred safe access points) that the AI model 502 believes should correspond to the training input 1802. In contrast, the ground-truth annotation 1804 can be considered as the correct/accurate safety classification label (e.g., as the correct/accurate risk level, the correct/accurate hostile environment indicator, the correct/accurate safe access points) that is known or deemed to correspond to the training input 1802. Note that, if the AI model 502 has so far undergone no or little training, then the output 1806 can be highly inaccurate. In other words, the output 1806 can be very different from the ground-truth annotation 1804.

In various aspects, the training component 1602 can compute one or more errors or losses (e.g., MAE, MSE, cross-entropy) between the output 1806 and the ground-truth annotation 1804. In various instances, the training component 1602 can incrementally update, via backpropagation, the trainable internal parameters of the AI model 502, based on such one or more errors or losses.

In various cases, the training component 1602 can repeat such execution-and-update procedure for each training input in the training dataset 1604. This can ultimately cause the trainable internal parameters of the AI model 502 to become iteratively optimized for accurately detecting objects 602 and objects 608 in inputted vicinity data, accurately determining access points 702, and accurately generating safety classification label 902. In various aspects, the training component 1602 can implement any suitable training batch sizes, any suitable error/loss functions, or any suitable training termination criteria.

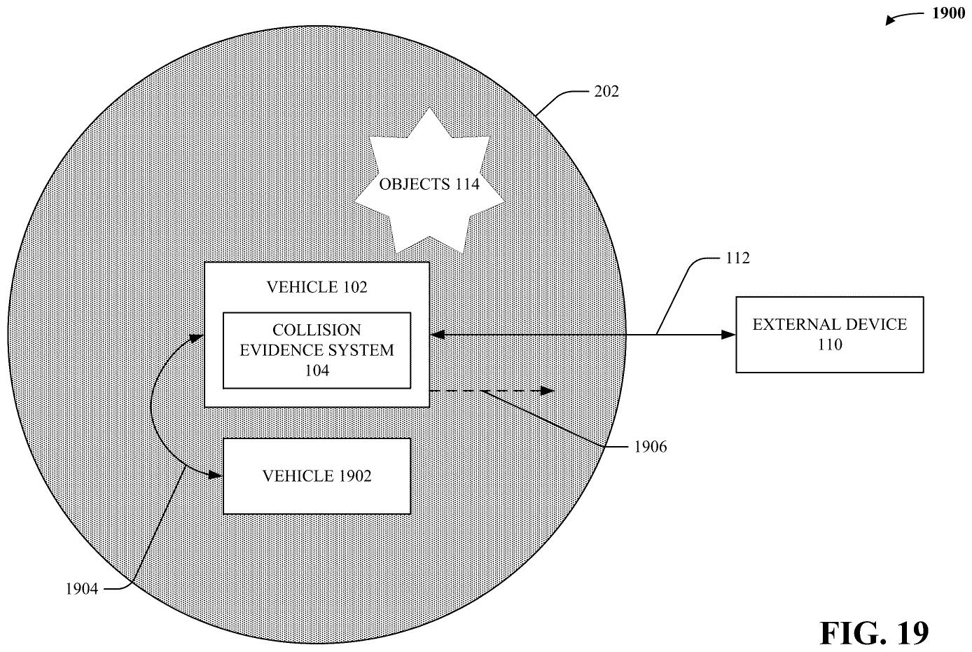

FIG. 19 illustrates an example, non-limiting block diagram 1900 showing a neighboring vehicle within a vicinity of vehicle 102 that can facilitate artificially intelligent vehicle storage assistance in accordance with one or more embodiments described herein.

In various instances, the detection component 310 can detect a neighboring vehicle 1902 near vehicle 102. Furthermore, in various cases, there can be objects 114 around vehicle 102 that are preventing safe opening of access points 702 for assisting passenger 106. Accordingly, in such scenario, the AI model 502 can determine vehicle operation adjustments 1202 to enable safe opening of access points 702 (e.g., to enable the driver door to open fully). For instance, the vehicle operation adjustments 1202 can cause vehicle 102 to reverse a distance 1906.

In such situation, to mitigate potential property damage or personal harm, the notification component 1204 can generate and transmit electronic alert 1206 to vehicle 1902 via a communication link 1904. For instance, the vehicle 1902 can be communicatively coupled to the vehicle 102 via communication link 1904. In various aspects, the communication link 1904 can be like the communication link 112. That is, the communication link 1904 can, in some cases, be any suitable wireless Internet connection that utilizes intermediate access points or intermediate routers, or the communication link 1904 can, in other cases, be any suitable P2P connection that can operate in the absence of intermediate access points or intermediate routers (e.g., BLUETOOTH® P2P or Wi-Fi P2P). In other instances, the notification component 1204 can generate and play an audio alert external to the vehicle 102, informing pedestrians or vehicles around vehicle 102 that the vehicle 102 is performing operation adjustments (e.g., reversing).

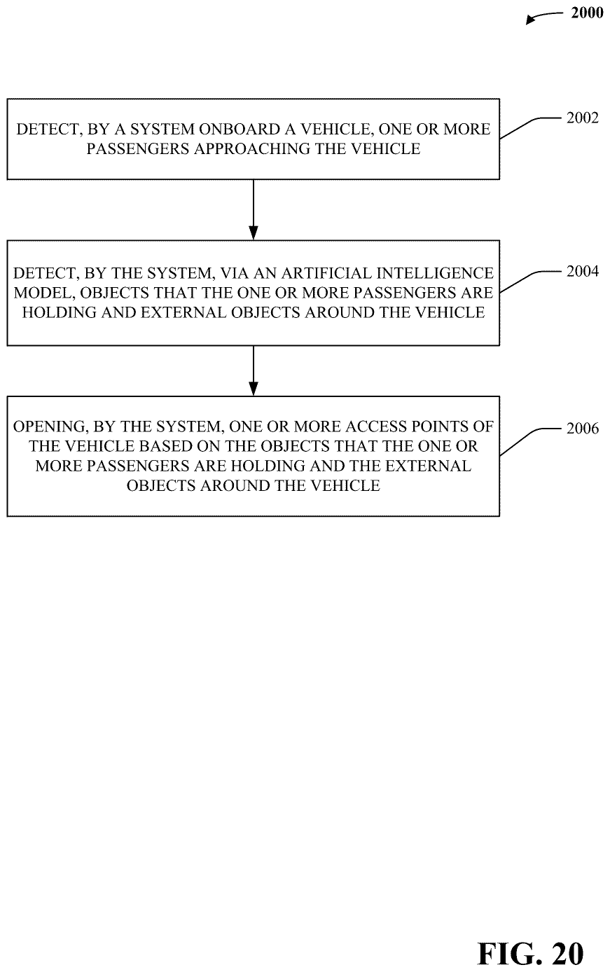

FIG. 20 illustrates a flow diagram of an example, non-limiting computer-implemented method 2000 that can facilitate artificially intelligent vehicle storage assistance in accordance with one or more embodiments described herein. In various cases, the vehicle storage assistance system 104 can facilitate the computer-implemented method 2000.

In various embodiments, act 2002 can include detecting, by a system (e.g., 308) onboard a vehicle (e.g., 102), one or more passengers (e.g., 106) approaching the vehicle.

In various aspects, act 2004 can include detecting, by the system (e.g., 310), via an AI model (e.g., 502), objects that the one or more passengers are holding (e.g., 602) and external objects around the vehicle (e.g., 608).

In various instances, act 2006 can include opening, by the system (e.g., 312), one or more access points (e.g., 702) of the vehicle based on the objects that the one or more passengers are holding and the external objects around the vehicle.

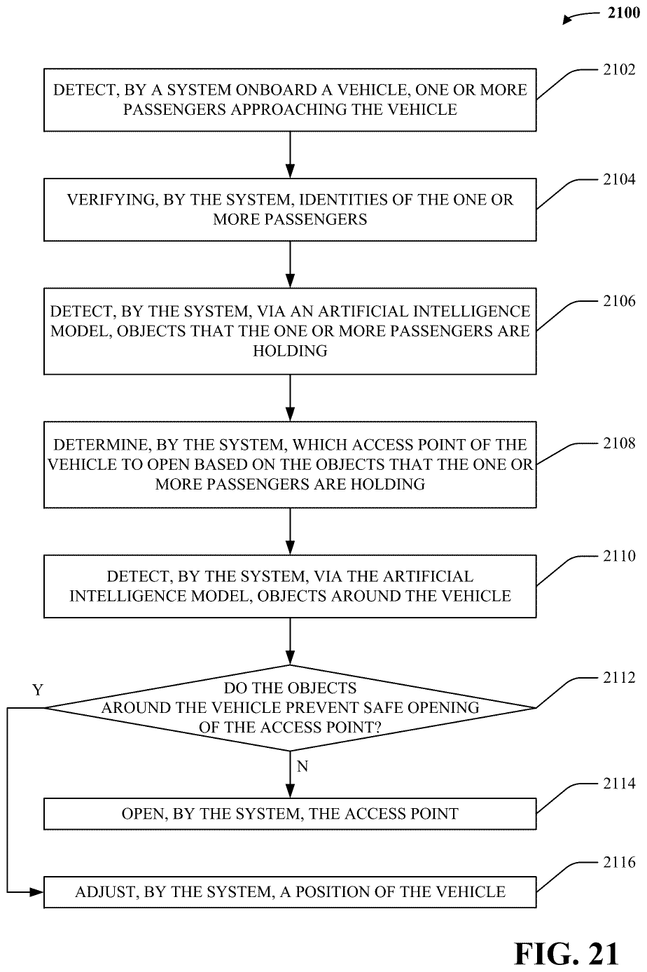

FIG. 21 illustrates a flow diagram of an example, non-limiting computer-implemented method 2100 that can facilitate artificially intelligent vehicle storage assistance in accordance with one or more embodiments described herein. In various cases, the vehicle storage assistance system 104 can facilitate the computer-implemented method 2100.

In various cases, act 2102 can include detecting, by a system (e.g., 308) onboard a vehicle (e.g., 102), one or more passengers (e.g., 106) approaching the vehicle.

In various aspects, act 2104 can include verifying, by the system (e.g., 308), identities of the one or more passengers.

In various embodiments, act 2106 can include detecting, by the system (e.g., 310), via an AI model (e.g., 502), objects that the one or more passengers are holding (e.g., 602).

In various aspects, act 2108 can include determining, by the system (e.g., 312), which access point (e.g., 702) of the vehicle to open based on the objects that the one or more passengers are holding.

In various instance, act 2110 can include detecting, by the system (e.g., 310), via the ai model, objects around the vehicle (e.g., 608).

In various aspects, act 2112 can include determining, by the system (e.g., via 310), whether the objects around the vehicle prevent safe opening of the access point. If not (e.g., if the objects around the vehicle do not prevent safe opening of the access point), the computer-implemented method 2100 can proceed to act 2114. If so (e.g., if the objects around the vehicle prevent safe opening of the access point), the computer-implemented method 2100 can proceed to act 2116.

In various aspects, act 2114 can include opening, by the system (e.g., via 312) the access point.

In various aspects, act 2116 can include adjusting, by the system (e.g., via 312) a position of the vehicle. Alternatively, an alternative access point can be opened to enable adaptable storage assistance for passenger 106.

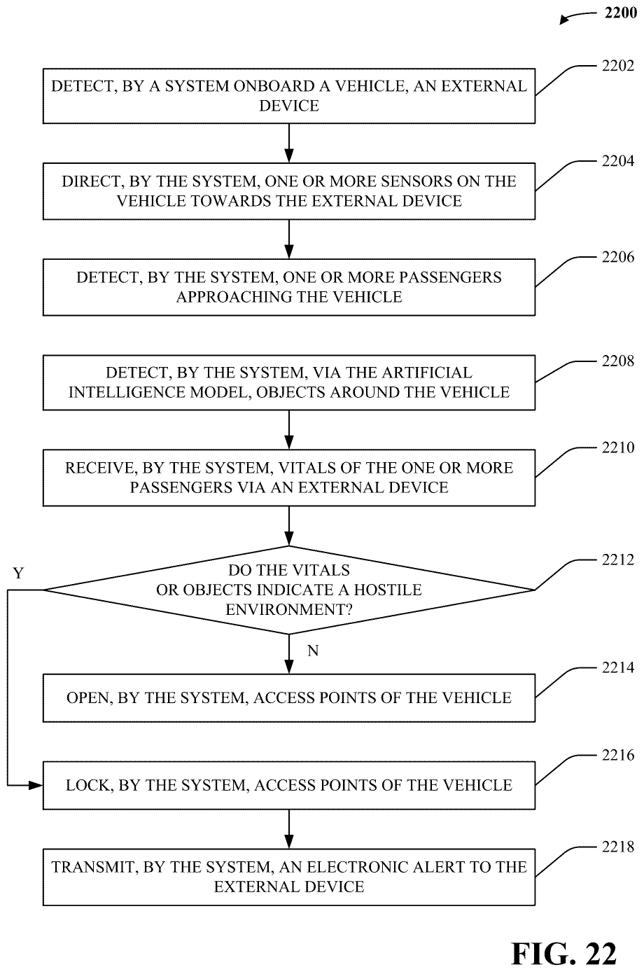

FIG. 22 illustrates a flow diagram of an example, non-limiting computer-implemented method 2200 that can facilitate artificially intelligent vehicle storage assistance in accordance with one or more embodiments described herein. In various cases, the vehicle storage assistance system 104 can facilitate the computer-implemented method 2200.

In various aspects, act 2202 can include detecting, by a system (e.g., 310) onboard a vehicle (e.g., 102), an external device (e.g., 110).

In various aspects, act 2204 can include directing, by the system (e.g., 306), one or more sensors on the vehicle towards the external device.

In various aspects, act 2206 can include detecting, by the system (e.g., 308), one or more passengers (e.g., 106) approaching the vehicle.

In various aspects, act 2208 can include detecting, by the system (e.g., 310), via an AI model (e.g., 502), objects around the vehicle (e.g., 608).

In various aspects, act 2210 can include receiving, by the system (e.g., 1204), vitals of the one or more passengers via the external device.

In various aspects, act 2212 can include determining, by the system (e.g., via 310), whether the vitals or objects indicate a hostile environment. If not (e.g., if the vitals or objects do not indicate a hostile environment), the computer-implemented method 2200 can proceed to act 2214. If so (e.g., if the vitals or objects indicate a hostile environment), the computer-implemented method 2200 can proceed to act 2216.

In various aspects, act 2216 can include locking, by the system (e.g., via 312), access points (e.g., 702) of the vehicle.

In various aspects, act 2218 can include transmitting, by the system (e.g., via 1204), an electronic alert (e.g., 1206) to the external device.

Although the herein disclosure mainly describes various embodiments as generating a classification label (e.g., 902) indicating whether an environment within vicinity 202 is safe or indicating characteristics, properties, or attributes of the environment, this is a mere non-limiting example. In various aspects, the herein-described deep learning neural networks (e.g., 402, 2102) can be configured to generate any suitable format or dimensionality of output (e.g., can be configured to produce bonding boxes or pixel-wise segmentation masks; are not limited only to producing classification labels).

Although the herein disclosure mainly describes various embodiments as implementing AI models (e.g., 502), this is a mere non-limiting example. In various aspects, the herein-described teachings can be implemented via any suitable machine learning models exhibiting any suitable artificial intelligence architectures (e.g., support vector machines, naïve Bayes, linear regression, logistic regression, decision trees, random forest).

Although the herein disclosure mainly describes various embodiments as detecting whether one passenger is approaching the vehicle, this is a mere non-limiting example. In various aspects, the herein-described teachings can be extrapolated to detecting whether one or more passengers are approaching the vehicle and detecting objects that the one or more passengers are holding to determine which access points to open.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence(class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

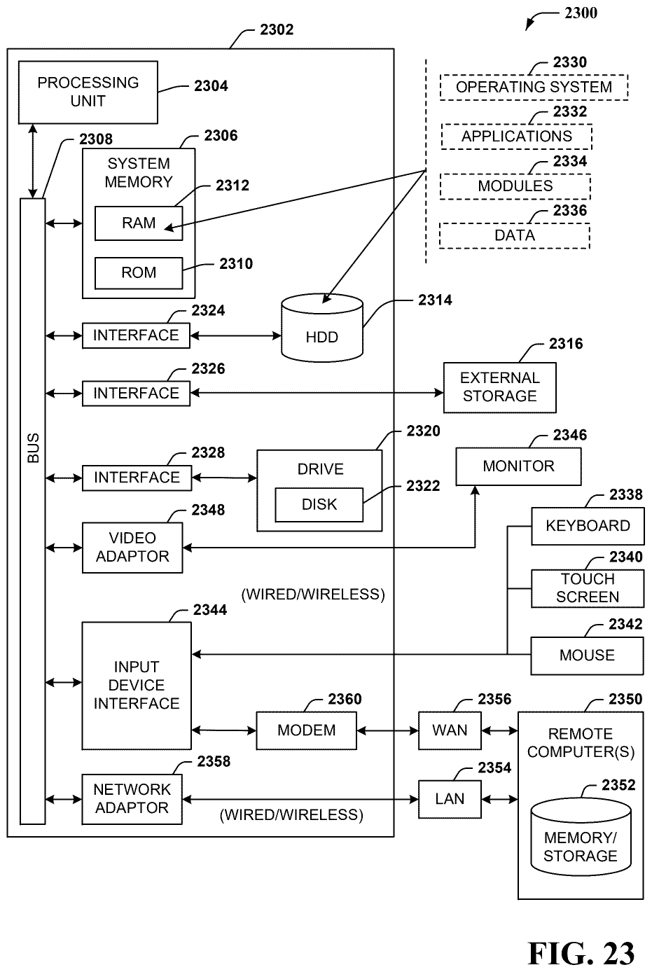

In order to provide additional context for various embodiments described herein, FIG. 23 and the following discussion are intended to provide a brief, general description of a suitable computing environment 2300 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 23, the example environment 2300 for implementing various embodiments of the aspects described herein includes a computer 2302, the computer 2302 including a processing unit 2304, a system memory 2306 and a system bus 2308. The system bus 2308 couples system components including, but not limited to, the system memory 2306 to the processing unit 2304. The processing unit 2304 can be any of various commercially available processors. Dual microprocessors and other multi-processor architectures can also be employed as the processing unit 2304.

The system bus 2308 can be any of several types of bus structure that can further interconnect to a memory bus (with or without a memory controller), a peripheral bus, and a local bus using any of a variety of commercially available bus architectures. The system memory 2306 includes ROM 2310 and RAM 2312. A basic input/output system (BIOS) can be stored in a non-volatile memory such as ROM, erasable programmable read only memory (EPROM), EEPROM, which BIOS contains the basic routines that help to transfer information between elements within the computer 2302, such as during startup. The RAM 2312 can also include a high-speed RAM such as static RAM for caching data.

The computer 2302 further includes an internal hard disk drive (HDD) 2314 (e.g., EIDE, SATA), one or more external storage devices 2316 (e.g., a magnetic floppy disk drive (FDD) 2316, a memory stick or flash drive reader, a memory card reader, etc.) and a drive 2320, e.g., such as a solid state drive, an optical disk drive, which can read or write from a disk 2322, such as a CD-ROM disc, a DVD, a BD, etc. Alternatively, where a solid state drive is involved, disk 2322 would not be included, unless separate. While the internal HDD 2314 is illustrated as located within the computer 2302, the internal HDD 2314 can also be configured for external use in a suitable chassis (not shown). Additionally, while not shown in environment 2300, a solid state drive (SSD) could be used in addition to, or in place of, an HDD 2314. The HDD 2314, external storage device(s) 2316 and drive 2320 can be connected to the system bus 2308 by an HDD interface 2324, an external storage interface 2326 and a drive interface 2328, respectively. The interface 2324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2312, including an operating system 2330, one or more application programs 2332, other program modules 2334 and program data 2336. All or portions of the operating system, applications, modules, or data can also be cached in the RAM 2312. The systems and methods described herein can be implemented utilizing various commercially available operating systems or combinations of operating systems.

Computer 2302 can optionally comprise emulation technologies. For example, a hypervisor (not shown) or other intermediary can emulate a hardware environment for operating system 2330, and the emulated hardware can optionally be different from the hardware illustrated in FIG. 23. In such an embodiment, operating system 2330 can comprise one virtual machine (VM) of multiple VMs hosted at computer 2302. Furthermore, operating system 2330 can provide runtime environments, such as the Java runtime environment or the .NET framework, for applications 2332. Runtime environments are consistent execution environments that allow applications 2332 to run on any operating system that includes the runtime environment. Similarly, operating system 2330 can support containers, and applications 2332 can be in the form of containers, which are lightweight, standalone, executable packages of software that include, e.g., code, runtime, system tools, system libraries and settings for an application.

Further, computer 2302 can be enable with a security module, such as a trusted processing module (TPM). For instance with a TPM, boot components hash next in time boot components, and wait for a match of results to secured values, before loading a next boot component. This process can take place at any layer in the code execution stack of computer 2302, e.g., applied at the application execution level or at the operating system (OS) kernel level, thereby enabling security at any level of code execution.

A user can enter commands and information into the computer 2302 through one or more wired/wireless input devices, e.g., a keyboard 2338, a touch screen 2340, and a pointing device, such as a mouse 2342. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2304 through an input device interface 2344 that can be coupled to the system bus 2308, but can be connected by other interfaces, such as a parallel port, an IEEE 1394 serial port, a game port, a USB port, an IR interface, a BLUETOOTH® interface, etc.

A monitor 2346 or other type of display device can be also connected to the system bus 2308 via an interface, such as a video adapter 2348. In addition to the monitor 2346, a computer typically includes other peripheral output devices (not shown), such as speakers, printers, etc.

The computer 2302 can operate in a networked environment using logical connections via wired or wireless communications to one or more remote computers, such as a remote computer(s) 2350. The remote computer(s) 2350 can be a workstation, a server computer, a router, a personal computer, portable computer, microprocessor-based entertainment appliance, a peer device or other common network node, and typically includes many or all of the elements described relative to the computer 2302, although, for purposes of brevity, only a memory/storage device 2352 is illustrated. The logical connections depicted include wired/wireless connectivity to a local area network (LAN) 2354 or larger networks, e.g., a wide area network (WAN) 2356. Such LAN and WAN networking environments are commonplace in offices and companies, and facilitate enterprise-wide computer networks, such as intranets, all of which can connect to a global communications network, e.g., the Internet.

When used in a LAN networking environment, the computer 2302 can be connected to the local network 2354 through a wired or wireless communication network interface or adapter 2358. The adapter 2358 can facilitate wired or wireless communication to the LAN 2354, which can also include a wireless access point (AP) disposed thereon for communicating with the adapter 2358 in a wireless mode.

When used in a WAN networking environment, the computer 2302 can include a modem 2360 or can be connected to a communications server on the WAN 2356 via other means for establishing communications over the WAN 2356, such as by way of the Internet. The modem 2360, which can be internal or external and a wired or wireless device, can be connected to the system bus 2308 via the input device interface 2344. In a networked environment, program modules depicted relative to the computer 2302 or portions thereof, can be stored in the remote memory/storage device 2352. It will be appreciated that the network connections shown are example and other means of establishing a communications link between the computers can be used.

When used in either a LAN or WAN networking environment, the computer 2302 can access cloud storage systems or other network-based storage systems in addition to, or in place of, external storage devices 2316 as described above, such as but not limited to a network virtual machine providing one or more aspects of storage or processing of information. Generally, a connection between the computer 2302 and a cloud storage system can be established over a LAN 2354 or WAN 2356 e.g., by the adapter 2358 or modem 2360, respectively. Upon connecting the computer 2302 to an associated cloud storage system, the external storage interface 2326 can, with the aid of the adapter 2358 or modem 2360, manage storage provided by the cloud storage system as it would other types of external storage. For instance, the external storage interface 2326 can be configured to provide access to cloud storage sources as if those sources were physically connected to the computer 2302.

The computer 2302 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

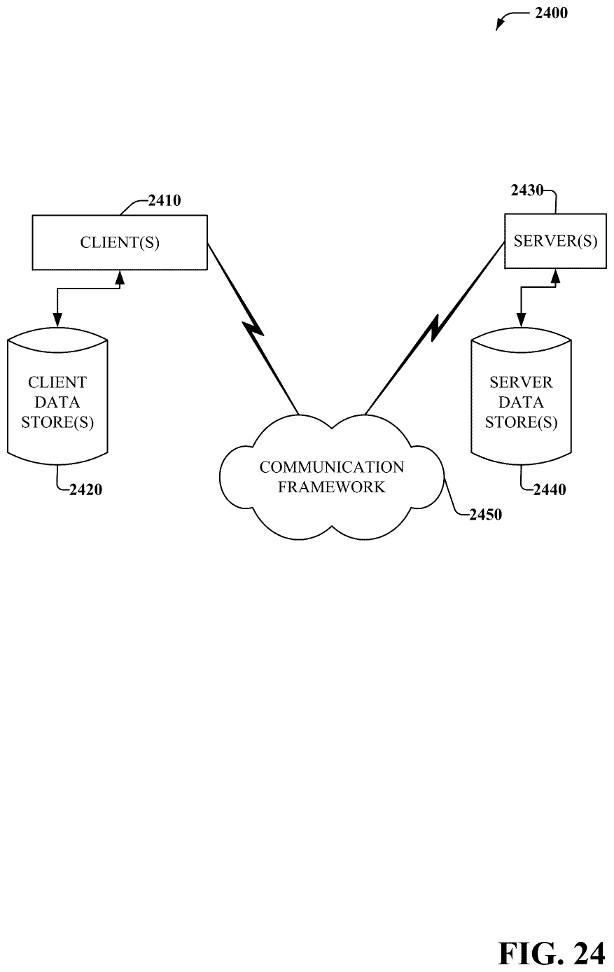

FIG. 24 is a schematic block diagram of a sample computing environment 2400 with which the disclosed subject matter can interact. The sample computing environment 2400 includes one or more client(s) 2410. The client(s) 2410 can be hardware or software (e.g., threads, processes, computing devices). The sample computing environment 2400 also includes one or more server(s) 2430. The server(s) 2430 can also be hardware or software (e.g., threads, processes, computing devices). The servers 2430 can house threads to perform transformations by employing one or more embodiments as described herein, for example. One possible communication between a client 2410 and a server 2430 can be in the form of a data packet adapted to be transmitted between two or more computer processes. The sample computing environment 2400 includes a communication framework 2450 that can be employed to facilitate communications between the client(s) 2410 and the server(s) 2430. The client(s) 2410 are operably connected to one or more client data store(s) 2420 that can be employed to store information local to the client(s) 2410. Similarly, the server(s) 2430 are operably connected to one or more server data store(s) 2440 that can be employed to store information local to the servers 2430.

The present invention may be a system, a method, an apparatus or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations or block diagrams of methods, apparatus (systems), and computer program products according to embodiments of the invention. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various non-limiting aspects of various embodiments described herein are presented in the following clauses.
Clause 1: A system located onboard a vehicle, comprising: a memory that stores computer executable components and a processor that executes the computer executable components stored in the memory, wherein the computer executable components comprise: a recognition component that detects one or more passengers approaching the vehicle; a detection component that detects, via an artificial intelligence (AI) model, objects that the one or more passengers are holding and external objects around the vehicle; and an execution component that opens one or more access points of the vehicle based on the objects that the one or more passengers are holding and the external objects around the vehicle.
Clause 2: The system of any preceding clause, wherein the detection component determines, via the AI model, which of the one or more access points to open based on a type or size of the objects that the one or more passengers are holding, wherein the detection component determines, via the AI model, if it is safe to open the one or more access points based on the external objects, and wherein the execution component adjusts operations of the vehicle in response to a determination that it is not safe to open the one or more access points..
Clause 3: The system of any preceding clause, wherein the recognition component determines a closest access point to the one or more passengers, wherein the detection component detects if a seat or trunk accessible from the closest access point is full, and wherein the execution component opens an alternative access point in response to detecting that the seat or trunk is full.
Clause 4: The system of any preceding clause, wherein the recognition component verifies identities of the one or more passengers via facial recognition or voice recognition.
Clause 5: The system of any preceding clause, wherein the recognition component detects an external device within a vicinity and directs one or more sensors on the vehicle towards the external device to detect the one or more passengers.
Clause 6: The system of any preceding clause, wherein the detection component determines, via the AI model, if the external objects around the vehicle are hazardous for opening any of the one or more access points.
Clause 7: The system of any preceding clause, wherein the execution component adjusts a position of the vehicle in response to a determination that the objects around the vehicle are hazardous.
Clause 8: The system of any preceding clause, wherein the execution component opens an alternative access point in response to a determination that the objects around the vehicle are hazardous.
Clause 9: The system of any preceding clause, wherein the detection component detects, via the AI model, external conditions of the vehicle, and wherein the execution component controls vehicle operations based on the external conditions.
Clause 10: The system of any preceding clause, wherein the detection component determines, via the AI model, if there is a hostile environment based on the external objects and locks the one or more access points in response to a determination that there is a hostile environment.
Clause 11: The system of any preceding clause, wherein the detection component determines, via the AI model, a maximum angle to open the one or more access points based on the external objects.
Clause 12: The system of any preceding clause, wherein the computer executable components further comprise: a notification component that generates an alert in response to opening the one or more access points or adjusting the position of the vehicle.
Clause 13: The system of any preceding clause, wherein the one or more access points comprise at least one of: a trunk, a hatch, one or more doors, or one or more windows.
Clause 14: The system of any preceding clause, wherein the detection component accesses vital signs of the one or more passengers via an external device to determine if there is a hostile environment.

In various cases, any suitable combination or combinations of clauses 1-14 can be implemented.
Clause 15: A computer-implemented method, comprising: detecting, by a system onboard a vehicle and comprising a processor, one or more passengers approaching the vehicle; detecting, by the system, via an artificial intelligence (AI) model, objects that the one or more passengers are holding and external objects around the vehicle; and opening, by the system, one or more access points of the vehicle based on the objects that the one or more passengers are holding and the external objects around the vehicle.
Clause 16: The computer-implemented method of any preceding clause, further comprising: determining, by the system, via the AI model, which of the one or more access points to open based on a type or size of the objects that the one or more passengers are holding; determining, by the system, determines, via the AI model, if it is safe to open the one or more access points based on the external objects; and adjusting, by the system, operations of the vehicle in response to a determination that it is not safe to open the one or more access points.
Clause 17: The computer-implemented method of any preceding clause, further comprising: determining, by the system, a closest access point to the one or more passengers; detecting, by the system, if a seat or trunk accessible from the closest access point is full; and opening, by the system, an alternative access point in response to detecting that the seat or trunk is full.
Clause 18: The computer-implemented method of any preceding clause, further comprising: verifying, by the system, identities of the one or more passengers via facial recognition or voice recognition.
Clause 19: The computer-implemented method of any preceding clause, further comprising: determining, by the system, via the AI model, if there is a hostile environment based on the external objects; and locking, by the system, the one or more access points in response to a determination that there is a hostile environment.

In various cases, any suitable combination or combinations of clauses 15-19 can be implemented.
Clause 20: A computer program product for facilitating artificially intelligent vehicle storage assistance stored on a non-transitory machine-readable storage medium, comprising executable instructions that, when executed by a processor onboard a vehicle, facilitate performance of operations, comprising: detecting one or more passengers approaching the vehicle; detecting, via an artificial intelligence model, objects that the one or more passengers are holding and external objects around the vehicle; and opening one or more access points of the vehicle based on the objects that the one or more passengers are holding and the external objects around the vehicle.

In various cases, any suitable combination or combinations of clauses 1-20 can be implemented.

What is claimed is:

1. A system, located onboard a vehicle, comprising:
a memory that stores computer executable components; and
a processor that executes the computer executable components stored in the memory, wherein the computer executable components comprise:
a recognition component that detects one or more passengers approaching the vehicle;
a detection component that detects, via an artificial intelligence (AI) model, objects that the one or more passengers are holding and external objects around the vehicle; and
an execution component that opens one or more access points of the vehicle based on the objects that the one or more passengers are holding and the external objects around the vehicle.

2. The system of claim 1, wherein the detection component determines, via the AI model, which of the one or more access points to open based on a type or size of the objects that the one or more passengers are holding,
wherein the detection component determines, via the AI model, if it is safe to open the one or more access points based on the external objects, and
wherein the execution component adjusts operations of the vehicle in response to a determination that it is not safe to open the one or more access points.

3. The system of claim 1, wherein the recognition component determines a closest access point to the one or more passengers,
wherein the detection component detects if a seat or trunk accessible from the closest access point is full, and
wherein the execution component opens an alternative access point in response to detecting that the seat or trunk is full.

4. The system of claim 1, wherein the recognition component verifies identities of the one or more passengers via facial recognition or voice recognition.

5. The system of claim 1, wherein the recognition component detects an external device within a vicinity and directs one or more sensors on the vehicle towards the external device to detect the one or more passengers.

6. The system of claim 1, wherein the detection component determines, via the AI model, if the external objects around the vehicle are hazardous for opening any of the one or more access points.

7. The system of claim 6, wherein the execution component adjusts a position of the vehicle in response to a determination that the objects around the vehicle are hazardous.

8. The system of claim 6, wherein the execution component opens an alternative access point in response to a determination that the objects around the vehicle are hazardous.

9. The system of claim 1, wherein the detection component detects, via the AI model, external conditions of the vehicle, and wherein the execution component controls vehicle operations based on the external conditions.

10. The system of claim 1, wherein the detection component determines, via the AI model, if there is a hostile environment based on the external objects and locks the one or more access points in response to a determination that there is a hostile environment.

11. The system of claim 1, wherein the detection component determines, via the AI model, a maximum angle to open the one or more access points based on the external objects.

12. The system of claim 7, wherein the computer executable components further comprise:
a notification component that generates an alert in response to opening the one or more access points or adjusting the position of the vehicle.

13. The system of claim 1, wherein the one or more access points comprise at least one of: a trunk, a hatch, one or more doors, or one or more windows.

14. The system of claim 1, wherein the detection component accesses vital signs of the one or more passengers via an external device to determine if there is a hostile environment.

15. A computer-implemented method, comprising:
detecting, by a system onboard a vehicle and comprising a processor, one or more passengers approaching the vehicle;
detecting, by the system, via an artificial intelligence (AI) model, objects that the one or more passengers are holding and external objects around the vehicle; and
opening, by the system, one or more access points of the vehicle based on the objects that the one or more passengers are holding and the external objects around the vehicle.

16. The computer-implemented method of claim 15, further comprising:
determining, by the system, via the AI model, which of the one or more access points to open based on a type or size of the objects that the one or more passengers are holding;
determining, by the system, determines, via the AI model, if it is safe to open the one or more access points based on the external objects; and
adjusting, by the system, operations of the vehicle in response to a determination that it is not safe to open the one or more access points.

17. The computer-implemented method of claim 15, further comprising:
determining, by the system, a closest access point to the one or more passengers;
detecting, by the system, if a seat or trunk accessible from the closest access point is full; and
opening, by the system, an alternative access point in response to detecting that the seat or trunk is full.

18. The computer-implemented method of claim 15, further comprising:
verifying, by the system, identities of the one or more passengers via facial recognition or voice recognition.

19. The computer-implemented method of claim 15, further comprising:
determining, by the system, via the AI model, if there is a hostile environment based on the external objects; and
locking, by the system, the one or more access points in response to a determination that there is a hostile environment.

20. A computer program product stored on a non-transitory machine-readable storage medium, comprising executable instructions that, when executed by a processor onboard a vehicle, facilitate performance of operations, comprising:
detecting one or more passengers approaching the vehicle;
detecting, via an artificial intelligence (AI) model, objects that the one or more passengers are holding and external objects around the vehicle; and
opening one or more access points of the vehicle based on the objects that the one or more passengers are holding and the external objects around the vehicle.
